(19) United States
(12) Patent Application Publication
(10) Pub. No.: US 2026/0310767 A1
(43) Pub. Date: Oct. 8, 2026

(54) SYSTEM, METHOD AND COMPUTER PROGRAM PRODUCT FOR BIOMETRIC SUPPORT FOR A VIRTUAL MOBILE DEVICE PLATFORM

(71) Applicant: HYPORI, INC., Reston, VA (US)

(72) Inventors: Brian J. VETTER, Austin, TX (US); Mohammad Salman DHEDHI, Round Rock, TX (US)

(21) Appl. No.: 19/172,621

(22) Filed: Apr. 7, 2025

(51) Int. Cl. G06F 21/32; G06F 21/12; G06F 21/34

(52) U.S. Cl. CPC G06F 21/32; G06F 21/123; G06F 21/34

(57) ABSTRACT

A method may include storing a biometric key for a user of a physical device captured by the biometric hardware on the physical device, prior to requesting a virtual device on the physical device. The virtual device may be requested for access to an application on the virtual device. The biometric key may be registered when the virtual device is requested by the user of the physical device. In addition, the method may include receiving a challenge from the virtual device in response to the request. The user of the physical device may be prompted to perform biometric authentication using the biometric key. In response to the challenge, proof may be provided to the virtual device that the user successfully performed the biometric authentication. Authorization may be received from the virtual device to access the application based on the provided proof.

### FIELD

This disclosure relates generally to a virtual mobile device platform. More particularly, embodiments disclosed herein relate to a system, method, and computer program product for allowing biometric access to virtual devices.

### BACKGROUND

Mobile devices such as smart phones and tablets face a number of security issues. On one level, there is a risk that the mobile device itself may become suspect — how it was built, who has handled it from manufacturing through use, how it is used by the user, etc. Moreover, the device could be physically accessed or otherwise compromised in many ways. For instance, information stored or cached on a mobile device could be accessed while its owner is away (e.g., left on the table at a restaurant or on their desk at work, stolen, or lost) or the user may have downloaded an infected application or could be sent an infected document via email or instant messaging, or accessed an infected service.

Because a mobile device is exposed to the hostile environment, securing the physical device itself (e.g., via Tempest hardware, encrypted storage, biometrics, etc.) is not enough and can be very expensive to do a thorough job. Even with such security, infiltration from any portion of the stack — from the chips to the software that is installed to the data the device receives — leaves the device vulnerable to attacks from well-funded, motivated adversaries. Attempts to provide the level of separation needed within the actual device face many challenges, and at best are likely to become a very expensive niche proposition in the overall commercial mobility ecosystem.

One solution that goes beyond securing the physical device is to isolate the applications from the physical device itself. That is, applications and services can be removed from the physical device, including aspects of the device's operating environment, thereby protecting them from potential hostile actors. Instead, these functions are provided on protected hardware and software in a data center where they can be managed, monitored, repaired, and deployed under the care of information technology (IT) experts and administrators.

In this regard, virtual devices enable a high assurance computing environment, i.e., one that provides a certain level of assurance as to its behavior, useful in ensuring a level of secrecy for classified, confidential, or otherwise protected information. For instance, a high assurance operating system may permit only certain certified applications to access a particular portion of a memory on a device where sensitive information is stored.

In view of unique challenges in incorporating mobile devices such as smart phones and tablets into secure computing environments, there is room for innovations and improvements.

### SUMMARY

Some example embodiments may be directed to a method. The method may include storing a biometric key for a user of a physical device captured by the biometric hardware on the physical device, prior to requesting a virtual device on the physical device. The method may also include requesting the virtual device for access to an application on the virtual device. The method may further include registering the biometric key when the virtual device is requested by the user of the physical device. In addition, the method may include receiving, from the virtual device, a challenge in response to the request. The method may further include prompting the user of the physical device to perform biometric authentication using the biometric key. Further, the method may include providing, in response to the challenge, proof to the virtual device that the user successfully performed the biometric authentication. The method may also include receiving, from the virtual device, authorization to access the application based on the provided proof.

Other example embodiments may be directed to an apparatus. The apparatus may include at least one processor, and at least one memory including computer program code which, when executed by the at least one processor, cause the apparatus to at least store a biometric key for a user of the apparatus captured by the biometric hardware on the apparatus, prior to requesting a virtual device on the apparatus. The apparatus may also be caused to request the virtual device for access to an application on the virtual device. The apparatus may further be caused to register the biometric key when the virtual device is requested by the user of the apparatus. In addition, the apparatus may be caused to receive, from the virtual device, a challenge in response to the request. Further, the apparatus may be caused to prompt the user of the apparatus to perform biometric authentication using the biometric key. The apparatus may also be caused to provide, in response to the challenge, proof to the virtual device that the user successfully performed the biometric authentication. The apparatus may further be caused to receive, from the virtual device, authorization to access the application based on the provided proof.

Other example embodiments may be directed to an apparatus. The apparatus may include means for storing a biometric key for a user of the apparatus captured by the biometric hardware on the apparatus, prior to requesting a virtual device on the apparatus. The apparatus may also include means for requesting the virtual device for access to an application on the virtual device. The apparatus may further include means for registering the biometric key when the virtual device is requested by the user of the apparatus. In addition, the apparatus may include means for receiving, from the virtual device, a challenge in response to the request. In addition, the apparatus may include means for prompting the user of the apparatus to perform biometric authentication using the biometric key. The apparatus may also include means for providing, in response to the challenge, proof to the virtual device that the user successfully performed the biometric authentication. The apparatus may further include means for receiving, from the virtual device, authorization to access the application based on the provided proof.

In accordance with other example embodiments, a non-transitory computer readable medium may be encoded with instructions that may, when executed in hardware, perform a method. The method may include storing a biometric key for a user of a physical device captured by the biometric hardware on the physical device, prior to requesting a virtual device on the physical device. The method may also include requesting the virtual device for access to an application on the virtual device. The method may further include registering the biometric key when the virtual device is requested by the user of the physical device. In addition, the method may include receiving, from the virtual device, a challenge in response to the request. The method may further include prompting the user of the physical device to perform biometric authentication using the biometric key. Further, the method may include providing, in response to the challenge, proof to the virtual device that the user successfully performed the biometric authentication. The method may also include receiving, from the virtual device, authorization to access the application based on the provided proof.

Other example embodiments may be directed to an apparatus that may include circuitry configured to store a biometric key for a user of the apparatus captured by the biometric hardware on the apparatus, prior to requesting a virtual device on the apparatus. The apparatus may also include circuitry configured to request the virtual device for access to an application on the virtual device. The apparatus may further include circuitry configured to register the biometric key when the virtual device is requested by the user of the apparatus. In addition, the apparatus may include circuitry configured to receive, from the virtual device, a challenge in response to the request. Further, the apparatus may include circuitry configured to prompt the user of the apparatus to perform biometric authentication using the biometric key. The apparatus may also include circuitry configured to provide, in response to the challenge, proof to the virtual device that the user successfully performed the biometric authentication. The apparatus may further include circuitry configured to receive, from the virtual device, authorization to access the application based on the provided proof.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 depicts a diagrammatic representation of an example of an overall network environment in which embodiments disclosed herein may be implemented.

FIG. 2 depicts a diagrammatic representation of an example of a network architecture according to one embodiment.

FIG. 3 depicts a diagrammatic representation of an example of a system architecture according to one embodiment.

FIG. 4 depicts a diagrammatic representation of an example of virtual device containment and connections according to one embodiment.

FIG. 5 depicts a diagrammatic representation of an example of a channel based device mapping architecture according to one embodiment.

FIG. 6 depicts a diagrammatic representation of an example of virtualization server software architecture according to one embodiment.

FIG. 7 depicts a flowchart of a process for registering biometric information with a remotely hosted virtual device, according to one embodiment.

FIG. 8 depicts a flowchart of a process for using biometric information to provide authentication for accessing an application on a remotely hosted virtual device, according to one embodiment.

FIG. 9 depicts an example procedure for an application 925 to create a key, according to one embodiment.

FIG. 10A depicts an example flow diagram of biometric authentication for a lock screen in a virtual device according to one embodiment.

FIG. 10B depicts a continuation of the flow diagram of FIG. 10A according to an embodiment.

FIG. 11A depicts an example flow diagram of biometric authenticated cryptography in a virtual device according to one embodiment.

FIG. 11B depicts a continuation of the flow diagram of FIG. 11A according to one embodiment.

FIG. 11C depicts a continuation of the flow diagram of FIG. 11B according to an embodiment.

FIG. 12A depicts an example flow diagram of biometric authentication for a lock screen in a virtual device according to one embodiment.

FIG. 12B depicts a continuation of the flow diagram of FIG. 12A according to one embodiment.

FIG. 13 depicts an example flow diagram of biometric authenticate cryptography in a virtual device according to one embodiment.

FIG. 14 depicts an example flow diagram of a method according to one embodiment.

FIG. 15 depicts an apparatus according to one embodiment.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions, and/or rearrangements within the spirit and/or scope of the underlying inventive concept will become apparent to those skilled in the art from this disclosure.

As described above, a mobile device lives in a hostile world and, as such, securing the device itself may not be enough and/or possible. There is a desire to separate a physical device from applications that run on the device.

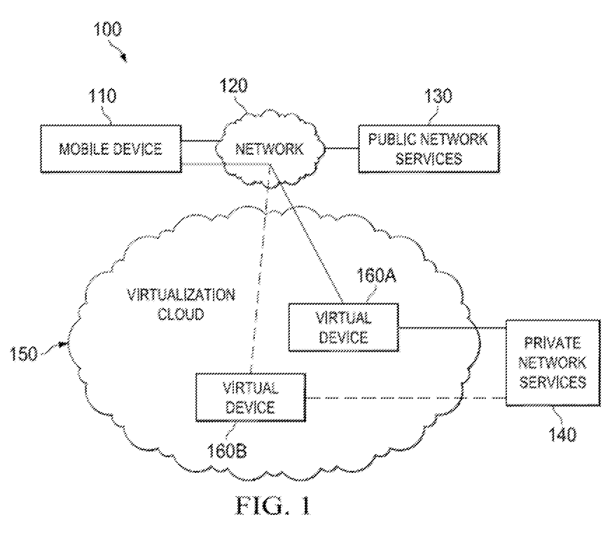

As illustrated in FIG. 1, embodiments disclosed herein can allow a user of mobile device 110 in network environment 100 to switch between using public network services 130 and using private network services 140. In particular, the user may access public network services 130 via public network 120 such as the Internet over which non-sensitive information may be communicated. However, to access private network services 140, a virtualization cloud client application (referred to hereinafter as a "VC client application") running on mobile device 110 connects to a virtualized device (e.g., virtual device 160A) hosted in virtualization cloud 150 and brokers access to private network services 140 as well as local device functions.

Those skilled in the art will appreciate that local device functions may vary depending upon the type of mobile device 110. For example, mobile device 110 can be a touchscreen smartphone with local device functions such as the touch screen, the dialer/phone network, camera, Global Positioning System (GPS), keyboard, speakers, microphone, and so on. Other examples of mobile device 110 may include touchscreen tablets and other touch-enabled mobile devices. As will be explained in further detail below, such mobile device functions can be provided by embodiments disclosed herein on protected hardware and software in virtualization cloud 150 without adversely affecting the user's experience in interacting with mobile device 110, even if the user travels frequently from one continent to another.

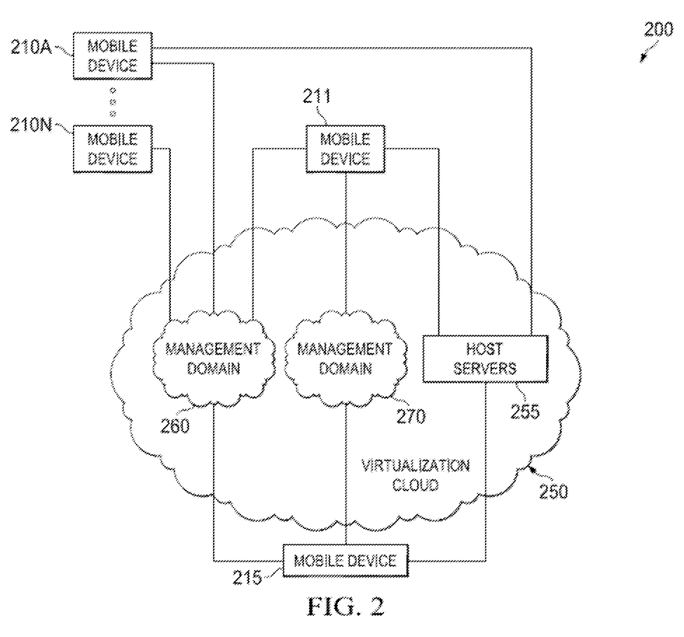

In some embodiments, multiple virtualized devices may be created for the same physical device. For example, in FIG. 1, virtual device 160A and virtual device 160B may be created for mobile device 110. This feature is further described below with reference to FIG. 2.

FIG. 2 depicts a diagrammatic representation of an example of a network architecture according to one embodiment. In this example, system 200 may include virtualization cloud 250 communicatively connected to various types of mobile devices 210A...210N, 211, and 215. Mobile devices 210A...210N, 211, and 215 may represent different types of actual touchscreen devices such as smartphones and tablets. Mobile devices 210A...210N, 211, and 215 may be owned by the same or different entities (e.g., enterprises, users, etc.). Further, mobile devices 210A...210N, 211, and 215 may be programmed with different operating systems such as iOS, Android, and Windows.

Each of mobile devices 210A...210N, 211, and 215 may have a VC client application installed, for instance, by an administrator or IT personnel of system 200. In one embodiment, a VC client application may be downloaded from an online device-specific app store.

In one embodiment, a VC client application may comprise software that brokers access to mobile devices' physical interfaces (e.g., soft and hard keyboards, touchscreen, GPS, camera, accelerometer, speakers, microphone, phone dialer, etc.) and Virtual Private Network (VPN) software that connects across a public network such as the Internet to servers in a virtualization cloud (e.g., virtualization cloud 150 of FIG. 1) over encrypted network interfaces. Virtualization cloud 250 may be an embodiment of virtualization cloud 150 described above with reference to FIG. 1.

Virtualization cloud 250 provides a hosted, networked, application environment. As a non-limiting example, in one embodiment, virtualization cloud 250 is configured as an Android application environment. As illustrated in FIG. 2, virtualization cloud 250 may comprise host servers 255 and management domains 260, 270.

Host servers 255 may host application services. Private network services 140 of FIG. 1 may be an embodiment of application services hosted by host servers 255 of FIG. 2. In one embodiment, a plurality of application services may execute on a collection of servers with extensions to support separation and segmentation of a core server.

Each management domain may comprise a collection of virtualized devices, hosted on one or more server machines. In an Android application environment, such virtualized devices may be referred to as virtual Android devices. From another perspective, a management domain is made up of a collection of server machines providing services to a large number of users. A collection of server machines may host virtual devices for these users and provide access to the applications and services via a remote client interface. In some embodiments, a management domain may further comprise a private application "store" for hosting installable approved enterprise applications particular to that management domain. In some embodiments, a user can have access to one or more "virtual devices" hosted in the management domain, each virtual device containing a core set of applications such as an enterprise address book, mail, calendar, web browser, etc. in addition to any preinstalled enterprise applications.

As FIG. 2 exemplifies, each mobile device (e.g., mobile device 210A, mobile device 211, mobile device 215, etc.) has a connection (via a VC client application installed thereon) to one or more server machines that host their virtual device(s) in a virtualization cloud (e.g., virtualization cloud 250). As explained below, the applications and their data located within a single virtual device are completely inaccessible to the applications and data in another virtual device. The applications are limited to the network services within their management domain and thus cannot access the network services provided in other management domains. For example, mobile device 210A may have a first virtual device hosted on a first server machine in management domain 260 and a second virtual device hosted on a second server machine in management domain 270. However, the applications and their data located within the first virtual device in management domain 260 are completely inaccessible to the applications and data within the second virtual device in management domain 270.

In some embodiments, for each connection to an application service hosted in the virtualization cloud, a different instance of the VC client application is started on the mobile device. For example, a first VC client instance may be started on mobile device 210A to access management domain 260 and a second VC client instance may be started on mobile device 210A to access management domain 270. All of the applications running in a particular management domain for a particular user will be accessed through the corresponding VC client application running on the mobile device. Additionally, the VC client application's remote connection software running in a mobile device does not expose application generated events running natively within the mobile device to the applications running in their virtual device(s), unless they are specific events from the devices brokered by the VC client application. In this way, rather than executing mobile applications in an actual device (e.g., mobile device 210A, etc.), the applications are run remotely in a virtualization cloud (e.g., virtualization cloud 250) under the watchful eyes of an enterprise's systems and network management tools and their administrators, separate from each other and from the consumer/Internet applications and data.

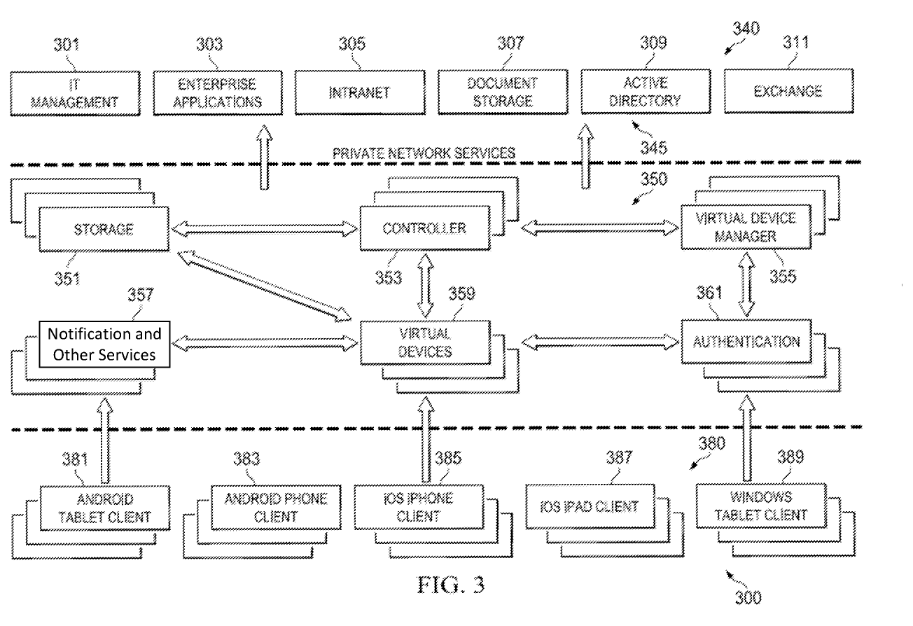

Turning now to FIG. 3, which depicts a diagrammatic representation of an example of a system architecture according to one embodiment. In this example, system 300 comprises virtualization cloud 350 communicatively connected to private network services 340 and various types of mobile devices 380.

Mobile devices 380 may operate in a distributed computing environment and may operate on various types of operating systems. Similar to mobile devices 110, 210A...210N, 211, 215 described above, each of mobile devices 380 may have a VC client application installed thereon. The installed VC client application may be device-specific. For example, each of Android tablets 381 may have an Android tablet client, each of Android phones 383 may have an Android phone client, each of iOS iPhones 385 may have an iOS iPhone client, each of iOS iPads 387 may have an iOS iPad client, and each of Windows tablets 389 may have a Windows tablet client.

Private network services 340 may comprise enterprise services for private network 345. Non-limiting examples of private network services 340 may include IT management 301, enterprise applications 303, intranet 305, document storage 307, active directory 309, and email exchange 311. These services are known to those skilled in the art and thus are not further described herein.

Virtualization cloud 350 may comprise a plurality of system components, including storage 351, controller 353, virtual device manager 355, notification and other services 357, virtual devices 359, and authentication 361. These system components may run on a single server machine or separately on multiple server machines. For the sake of convenience, and not of limitation, FIG. 3 shows each system component running on multiple physical servers.

More specifically, virtual device manager 355 (an application that manages virtual devices) may send a command to controller 353 to create a virtual device. In one embodiment, controller 353 may implement the OpenStack open source cloud computing fabric controller. OpenStack is known to those skilled in the art and thus is not further described herein for the sake of brevity. In certain embodiments, the controller 353 may be replaced with a combination of an Amazon Web Services (AWS) EC2 controller and AWS EC2 services where certain functions performed by the OpenStack may also be performed by the controller 353 or functions of the AWS EC2 controller. In response to the command from virtual device manager 355, controller 353 may first select a golden image, and any applications associated with the golden image. A golden image refers to a virtual machine that was built as a template and that usually contains little, if any, more than the base operating system. A golden image may also be referred to as a gold image, clone image, master image, or base image. To create a golden image, an administrator first sets up the computing environment exactly the way it is needed and then saves the disk image as a pattern for making more copies. The use of golden images can save time and ensure consistency by eliminating the need for repetitive configuration changes and performance tweaks. This approach can be compared to automated replication, which requires a configuration management tool to build new images on demand. In a self-service provisioning environment, a collection of golden images may be referred to as a golden repository, gold catalog, or golden image library.

Using the selected golden image, controller 353 may create virtual device instance 359 and associate with it a storage location in storage server 351. Storage server 351 holds the persisted, physical storage of each virtual device created by controller 353. Controller 353 may then return the information on virtual device instance 359 to virtual device manager 355.

In some embodiments, each user is assigned one or more virtual devices in one or more management domains when they are provisioned. These virtual "devices" contain applications, their settings and device configuration, as well as any data created locally in the device for the user by any installed applications. The images are maintained in network storage servers (e.g., storage servers 351) within the corresponding management domain(s). In some embodiments, as part of this image, the user is provided an emulated "flash" drive for app storage. The images can also be configured to permit access to external enterprise storage. In some embodiments, storage servers may utilize redundant storage to protect data from failures.

In some embodiments, authentication servers 361 may be configured to provide authentication and session management services. For example, when a user (via a VC client application running on a mobile device that the user is using) attempts to access an enterprise application, authentication server 361 may connect to one or more directory servers (e.g., active directory 309) to authenticate the user's access to virtual device(s) where the enterprise application can be run and to provision the user with one or more virtual devices. After the user authenticates, authentication server 361 may direct virtual device manager 355 to locate a device server that will host the user's virtual device 359. In some embodiments, it may ensure that virtual device 359 is "powered on" as well as initiate the initial session negotiation (via establishment of security tokens) between the mobile device running the VC client application and virtual device 359.

Those skilled in the art will appreciate that a virtual "device" is a not really a device — it is a remote execution environment for all of the services and applications that make up a device. There are (at least) two main classes of device servers, "bare metal" device servers and virtual machine device servers. There are some functional, deployment, and cost differences between these types and so ultimately implementation and market demand will determine their allocation and availability. In certain embodiments, the device servers and bare metal may be remnants of OpenStack. In the case of OpenStack, the device servers may hold more than 1. In the case of AWS, the device servers may not be bare metal, and may instead be AWS EC2 virtual machines.

The bare metal device servers are made up of a large number of relatively small processing units similar in performance and scale to the processing units of actual mobile devices. Each virtual device instance can run on its own physical central processing unit ("CPU") hardware. In some embodiments, a modified version of the Simple Protocol for Independent Computing Environments (SPICE) protocol server software executes directly in the operating system (OS) on each of these instances to provide remote access.

SPICE is an open source protocol and implementation developed by Red Hat that provides remote access to virtual desktops. SPICE has a well-documented protocol that includes the ability to create new "channels" for different remote services. Embodiments extend the SPICE protocol to provide remote access to virtual devices and to broker access to the sensors of the real (physical) devices. Other embodiments may make use of other protocols in place of SPICE or extended versions of SPICE. Other embodiments may make use of notional or logical channels, for example using gRPC, or more generally, groups in which a set of services are provided.

Virtual machine device servers are server class machines that can be found in the server market today. On the virtual machine device servers, each virtual "device" executes in its own virtual machine on a specially configured Linux device server. In some embodiments, a device server may be configured to provide Transport Layer Security (TLS) and VPN encryption, virtual device instrumentation/auditing, integrity checks and anti-virus from virtualization layer, system-side application management, learning of `normal' behavior, protocol aware firewall, server-side TPM attestation, SELinux-based virtual device separation, VPN service for applications in the virtual devices, and network proxy for traffic monitoring. Some of these features are further explained below.

In some embodiments, virtual devices hosting Android (or Security Enhancements for Android (SEAndroid)) may be created for each user using Linux's Kernel-based Virtual Machine (KVM) and Quick EMUlator (QEMU).

KVM refers to a kernel-resident virtual machine infrastructure built directly into Linux as opposed to other virtualization techniques that run under Linux as a process. This architecture helps KVM operate very efficiently within Linux. KVM provides completely separate virtual environments for Android devices implementing embodiments disclosed herein. KVM itself does not provide any hardware emulation or remoting capabilities.

QEMU is a user-space emulator that works with KVM to provide the hardware emulation. While QEMU can provide processor instruction emulation, embodiments employ it only for emulating hardware for the virtual device. For example, some embodiments use or provide emulated hardware for touch screen/display, memory/storage, audio, cameras, sensors, bypass, and networking.

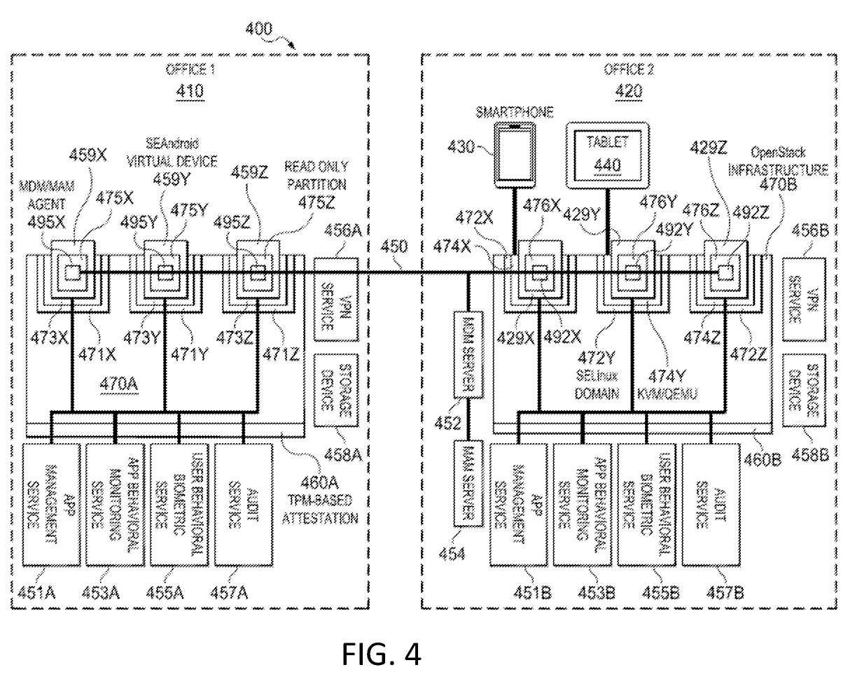

Linux and KVM provide the isolation between each user and the applications that they run. It is not possible to communicate directly between the application components and services in these separate virtual containers. Thus, each "device", while sharing physical server hardware, runs independently and is separate from the others, as depicted in FIG. 4.

FIG. 4 depicts a diagrammatic representation of an example of virtual device containment and connections according to one embodiment. In this example, virtualization cloud 400 may comprise management domain 410 (Office 1) and management domain 420 (Office 2).

Management domain 410 and management domain 420 may be hosted on device servers connected to management network 450 which provides a plurality of network services such as application management services 451A, 451B, application behavioral monitoring services 453A, 453B, user behavioral biometric services 455A, 455B, and audit services 457A, 457B.

Management domain 410 may comprise a plurality of virtual devices 459X, 459Y, 459Z implemented using OpenStack infrastructure 470A on Trusted Platform Module (TPM)-based attestation 460A. Each of the plurality of virtual devices 459X, 459Y, 459Z may include an agent of management network 450 (e.g., agents 495X, 495Y, 495Z, respectively). In some embodiments, the agent may be referred to as a mobile device management and mobile application management (MDM/MAM) agent. In this example, management domain 410 may further comprise VPN service 456A and storage service 458A.

Management domain 420 may comprise a plurality of virtual devices 429X, 429Y, 429Z implemented using OpenStack infrastructure 470B on TPM-based attestation 460B. Each of the plurality of virtual devices 429X, 429Y, 429Z may include an agent of management network 450 (e.g., agents 492X, 492Y, 492Z, respectively). In this example, management domain 420 may further comprise MDM server 452, MAM server 454, VPN service 456B, and storage service 458B.

As illustrated in FIG. 4, each of the plurality of virtual devices 459X, 459Y, 459Z in management domain 410 and each of the plurality of virtual devices 429X, 429Y, 429Z in management domain 420 has a read only partition and its own KVM/QEMU in a particular SELinux domain (e.g., read only partition 475X and KVM/QEMU 473X in SELinux domain 471X, read only partition 475Y and KVM/QEMU 473Y in SELinux domain 471Y, read only partition 475Z and KVM/QEMU 473Z in SELinux domain 471Z, read only partition 476X and KVM/QEMU 474X in SELinux domain 472X, read only partition 476Y and KVM/QEMU 474Y in SELinux domain 472Y, read only partition 476Z and KVM/QEMU 474Z in SELinux domain 472Z).

In the example of FIG. 4, the virtual devices are implemented as SEAndroid virtual devices. SEAndroid may provide benefits such as privileged daemon protection, application isolation, middleware controls, instrumentation and auditing, application install protection, limit application access to sensors, `untrusted' application sandboxing, read-only core OS partition, centralized patching, and MDM/MAM controls.

In some embodiments, virtual devices can be migrated between device servers by administrative commands (via management network 450), using tools to automate the balancing of load across multiple device servers or based on geographical location.

Each of these virtual devices may be connected to a physical mobile device (e.g., smartphone 430, tablet 440, etc.). In some embodiments, a VC client application running on the physical device may be configured to provide remote two factor authentication, remote signing and decryption, TLS encryption for data in transit, GPS-based access policies, attributes exposed for MDM integration, mechanisms to improve attestation, and/or integration with the mobile device's Mobile Trusted Module (MTM).

When a user is added to a management domain, they are provisioned with a virtual device of a particular type. Similarly, when a user is removed, their virtual devices must be deactivated and their "parts" archived or reclaimed. A separate management server is used by administrators to manage the lifecycle of devices and users of a virtualization cloud (e.g., virtualization cloud 150, virtualization cloud 250, virtualization cloud 350, virtualization cloud 400, etc., collectively referred to hereinafter as the "VC system"). In some embodiments, provisioning services permit administrators to define device "types" (templates) and configurations and assign them to users depending upon the role or duty.

In some embodiment, the management of the VC system and the virtual devices can be controlled through a management policy system. Servers, storage, and virtual devices can be associated with hierarchically arranged policy containers. Policies and access to components can be controlled through these containers and their position in the hierarchy. In some embodiment, these policy containers may be referred to as policy domains and can be used to allocate and delegate control to multiple administration management domains.

For example, consider a hosted VC environment. A hosting partner wishes to support multiple enterprise customers in a single installation. At the same time, they would like to delegate much of the management to their customers. They may choose to create a single policy domain that contains shared resources such as common virtual device images, common device storage, and a shared pool of device servers. For each new customer, they create a sub-domain and grant administrative access to the customers' administrators for their respective sub-domain. In addition, they create a policy in the root domain that all resources are accessible to the sub-domains. The customers' administrators can now create assets (new device image templates, users, administrators, groups) within their own sub-domain. They, in turn, can create their own sub-domains and assign assets, users, groups, administrators, etc. to those sub-domains as well as policies to determine how resources can be inherited from the companies' sub-domain.

If one of these customers wants dedicated server resources to run the virtual devices or to maintain their storage, the hosting partner can add device server and storage server resources to their sub-domain(s) and thus only their virtual devices will be running or be saved on those server assets. Similarly, those systems might have different networking characteristics that would let them share a VPN connection to the enterprise as opposed to configuring a VPN within each of the virtual devices.

This organization can also be beneficial to enterprises that need to delegate management functions to different departments within their enterprise yet want to control and maintain the overall infrastructure centrally.

When migrating a user between two templates, the VC system can support intelligent upgrading, including: Scheduling specific times for upgrades to occur; Roll back to a previous device template if an error occurs; Partial, incremental upgrade processes across a user population; Detection of whether a user is active on a virtual device before enacting the upgrade; and/or Graceful shut down of a virtual device for which an upgrade is being forced.

As a non-limiting example, in some embodiment, a provisioning and management server for the virtual machine device servers described above can be built on top of a virtual datacenter management platform such as OVirt, OpenStack, or the like. OVirt and OpenStack are known to those skilled in the art and thus are not further described herein. OVirt provides the underlying data services for managing and accessing virtual machines. The VC system provides an abstraction interface that hides much of the complexity of the underlying virtual datacenter management platform when trying to manage multiple management domains within a single system. In some embodiments, SPICE may be integrated into the virtual datacenter management platform, allowing users to connect to virtual machines through SPICE.

In some embodiments, an administrator might want to allow users to access a mobile virtual device without a persist state of the virtual device beyond a given user's session. In this case, the virtual device may be deleted when the session ends. In some embodiments, the virtual device may optionally warn the user that the virtual device is operating on a kiosk mode when the user logs in, and delete the virtual device when the user logs out. Essentially, the kiosk mode provides a `fresh' virtual device based on a specified template each time a user logs in.

In a variant of the kiosk mode, a virtual device can be set to synchronize certain enterprise data (e.g., recent email) when the user logs into the kiosk mode device, but the virtual device is still deleted when the user logs out. In this way, any new enterprise data is placed back into the enterprise applications that should own each respective data type. This allows the user to move between server node clusters (e.g., moving between countries) without concern about moving or synchronizing virtual device state between the different servers.

The VC system may support additional modes of operation. For instance, a published app mode may enable an organization to offer specific applications in remote `containers' to large user populations. An example would be a bank using the published app mode to make an online banking application available to its customers, while hosting that online banking application in their own data centers on their own locked down OS image.

In such a published app mode, the end client application icon can be customized to enable white labeling. For example, when the user logs in, the published application is already open and in focus. When the user quits the application, the remote connection closes. In some embodiments, the published app mode can be coupled with the kiosk mode described above such so that the virtual device does not have a persist state.

In some embodiments, an organization may wish to provision a virtual device (whether a full device, kiosk mode, published app, etc.) to a person not employed by that organization, and the user need only download a VC client application or add the account to their existing VC client application on their mobile device(s).

In some embodiments, an organization may wish to provision one or more virtual devices to one or more employees at a partner organization. In this case, the publishing organization can liaise with the consuming organization to add a VC client application and/or set of authentication settings to the consuming organization. One of the advantages of this approach is that the publishing organization can leverage the user provisioning and authentication mechanisms of the consuming organization. For example, access to the VC client application can become a setting in the consuming organization's active directory, and users in the consuming organization must already have authenticated to the consuming organization in order to have access to the publishing organization's applications / virtual devices.

In this scenario, doing two remoting steps would add latency and complexity to the VC system. To avoid this, when the user connects to the publishing organization's virtual device, the VC client application on the user's physical device can connect to the publishing organization's VC servers via a bypass channel in the VC server of the consuming organization.

As described above, SPICE can create new "channels" for different remote services. Different types of data can be communicated between a mobile device running a VC client application and a virtual device running in the VC system via different SPICE channels. These SPICE channels are mapped to virtual input/output channels.

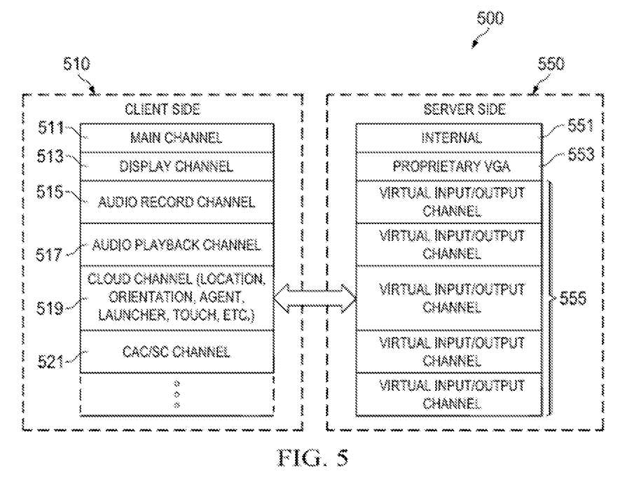

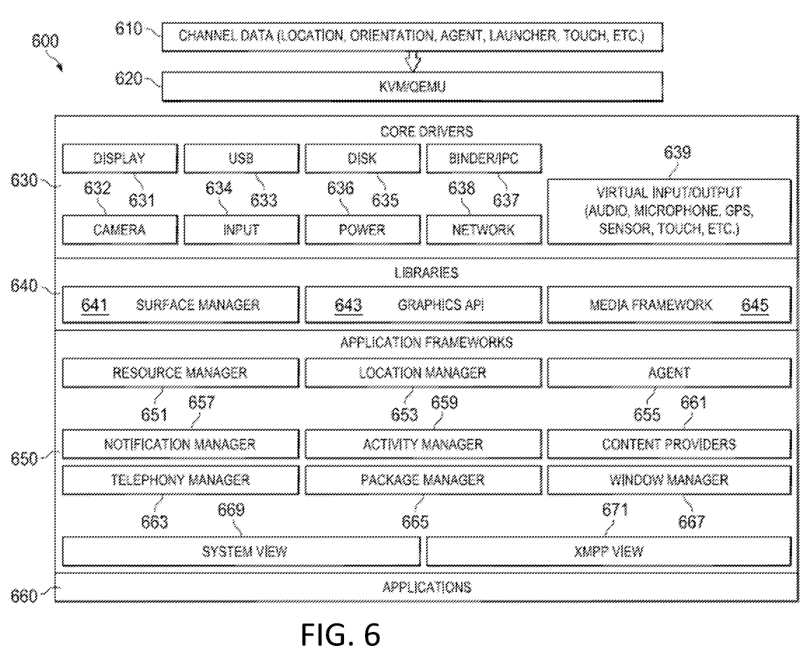

FIG. 5 depicts a diagrammatic representation of an example of channel based device mapping architecture 500 according to one embodiment. In this example, data (e.g., display data, audio data, location data, etc.) may be communicated from a mobile device (e.g., client side 510) via various SPICE channels (e.g., main channel 511, display channel 513, audio record channel 515, audio playback channel 517, cloud channel 519, Call Admission Control (CAC) / Signaling Controller (SC) channel 521, etc.) to a server in the VC system (e.g., server side 550). Channel based device mapping architecture 500 may include a virtual device mapping module embodied on a non-transitory computer readable medium and configured for mapping the incoming data to appropriate virtual device component (e.g., internal component 551, proprietary video graphic adapter (VGA) 553, etc.) and/or virtual input/output channels 555, each associated with a particular virtual driver. This is further described below with reference to FIG. 6.

FIG. 6 depicts a diagrammatic representation of an example of virtualization server software architecture according to one embodiment. As a non-limiting example, virtualization server software architecture 600 may implement a modified version of Android OS.

As illustrated in FIG. 6, virtualization server software architecture 600 may comprise a plurality of software components. At its core is a Linux kernel with specialized core drivers 630 to abstract the hardware layer from the application runtimes. Channel data 610 are received into a virtual device's KVM/QEMU 620, mapped via virtual input/output channels 639, and handled by corresponding virtual device drivers (e.g., display driver 631, universal serial bus (USB) driver 633, disk driver 635, binder / inter-process communication (IPC) driver 637, camera driver 632, input driver 634, power management 636, and network driver 638, etc.). These "virtual" device drivers replace the drivers for a real device and communicate using QEMU and the SPICE protocol with a VC client application executing on the mobile device for access to the real devices and the services they provide.

Virtualization server software architecture 600 may further comprise a collection of libraries for accessing data, working with text and graphics, encryption and communication, and the underlying OS. In the case of Android OS, each virtual device session includes a full complement of Android's application framework, libraries, runtime, and applications. However, some kernel-based services provided within a virtual device server are modified. For example, power management services are simulated and significantly altered as battery support is not an issue in a virtual device. User interface (UI) indicators for batteries and other elements not applicable to the virtual device can be made to reflect the values of the client device.

As another example, applications running in a virtual device do not use the local device's WiFi or data network. Instead, they use the Internet Protocol (IP)-based network services provided by the virtual device servers. In some embodiments, an "always-on" network interface may be provided to the applications. WiFi and data connectivity management applications the user may install in the virtual device may have no relevance.

Virtualization server software architecture 600 may include additional virtual drivers not shown in FIG. 6. Many of the virtual drivers may communicate with a VC client application running on a mobile device using extensions to the SPICE protocol. Some are designed to improve performance whereas others provide access to features expected in a mobile device. Some example virtual drivers are further described below.

Virtual sensors driver - provides access to the remote client's sensor devices such as the GPS, the gyroscope, the accelerometer, a compass, battery level, WiFi signal strength, and 3G/4G signal strength. Other sensor types can be added as needed.

When an application requests access to a sensor such as the GPS, the sensors driver sends a device message that results in a sensor request being sent to the remote client. The remote client application then makes a similar request to the physical device and begins forwarding sensor data back to the sensor driver as the sensor produces data. When the application no longer needs the sensor information, a close request is sent back to the client where it then stops monitoring the specified sensor.

Some sensors, such as the GPS, can draw significant battery power while running. To prevent unnecessary battery drain, the VC client application running on the physical mobile device can request that the GPS on the local mobile device be turned on or off based on the requirements of applications running on the virtual device in the VC system.

Some sensors such as the accelerometer may change values very frequently. The VC client application can be configured to sample and relay accelerometer values from the local physical device based on attributes and requirements of the app running on the virtual device in the VC system as well as the performance of the network connection between the local and virtual devices (higher network latency and lower available bandwidth result in fewer sensor values being communicated).

A specific example of this is in how the VC system synchronizes the orientation of the remote virtual device to the orientation of the local device by continually monitoring and relaying orientation change events on the accelerometer on the local device, while not relaying every minor rotation of the device all the time even if the application on the remote virtual device is not monitoring the accelerometer data.

Additional sensors that the VC system can remote from the local device to the virtual device may include the network type, network signal strength, battery charge remaining, light sensor (used for screen diming), Bluetooth, peripheral device connectivity and the state of any local payment credential.

Virtual touchscreen driver - supports remoting of multi-touch actions and also gestures. Multi-touch gestures can be used for zooming, rotating and other similar operations. In one embodiment, the SPICE mouse channel may be modified for this purpose. In some embodiments, a designated channel is used for this purpose.

Audio and video bypass driver - improves the performance of audio and video processing for both the VC server and the VC client. While embodiments can work without bypass, there is a CPU cost on both the client and the server when using the internal video processing of the host operating system (e.g., Android). To this end, modified media framework 645 is provided to replace audio and video players that came with the OS with special players that implement the bypass functions. For example, when an application requests to play a video using the Android video player (either full-screen or embedded), the bypass video player captures either the video data or an Universal Resource Locator (URL) that points to an address where the actual video file resides, and passes it via the bypass driver to the remote client. The client then spawns a local video player and plays the video stream. In the case of network video sources, the entire stream can be handled outside of the virtual device via a network proxy.

Audio bypass works much like video bypass. The audio player is replaced to provide proxy access to audio data in the client.

Virtual camera driver – remotes a camera using a combination of a virtual camera device driver and modifications to the camera functions in the media framework. When the camera activity or fragment is loaded in the virtual device, the modified camera viewer and virtual camera driver sends a request to the client to bring up the camera. Once a picture is taken, the picture or video is sent to the virtual device server where it can be placed in the flash storage of the virtual device or can be delivered to an anti-virus scanner and then placed in enterprise storage.

Virtual display driver - optimizes delivery of graphics to a remote client. More specifically, the graphics layer can be instrumented to generate messages via a virtual display driver instead of writing directly to a frame buffer. In some embodiments, surface manager 641 in libraries 640 is implemented to handle partial updates to the Android display. In some embodiments, surface manager 641 may work in conjunction with graphics API 643 to provide acceleration for various commands issued by applications and the Android OS.

These and other virtual drivers support remote access for applications 660 running on application frameworks 650 in the virtual device. Operation of the virtual device, including processes associated with applications 660, as well as user behaviors can be monitored via various components in application frameworks 650 (e.g., resource manager 651, location manger 653, agent 655, notification manager 657, activity manager 659, content providers 661, telephony manager 663, package manager 665, window manager 667, system view 669, and Extensible Messaging and Presence Protocol (XMPP) communications service 671, etc.).

In general, an application running in a virtual machine does not have access to any fingerprint or biometric hardware. Instead, the hardware to perform biometric measurements is associated with a user device, such as the mobile device 110. In an embodiment, a system is described that allows fingerprint authentication support from an application running in a virtual machine while the biometric identification hardware is physically located at the user device that may be connected to the virtual machine. In an embodiment, the mobile device and/or the virtual machine are running on an Android operating system, though in principle the concept may be applied to any number of different operating systems.

In an embodiment, the operating system includes a module for processing fingerprints, for example, in an Android system, the OS defines a fingerprint HIDL (Hardware Interface Definition Language) interface which can be used to implement a fingerprint HAL (Hardware Abstraction Layer), which is explained, for example, as an open source code program. The HAL may serve as an interface between the hardware and OS, and may provide a way for the software programs to interact with different hardware devices without specific knowledge of each hardware device. Using this HIDL interface, a fingerprint HAL can be added to a virtual device 160A or 160B.

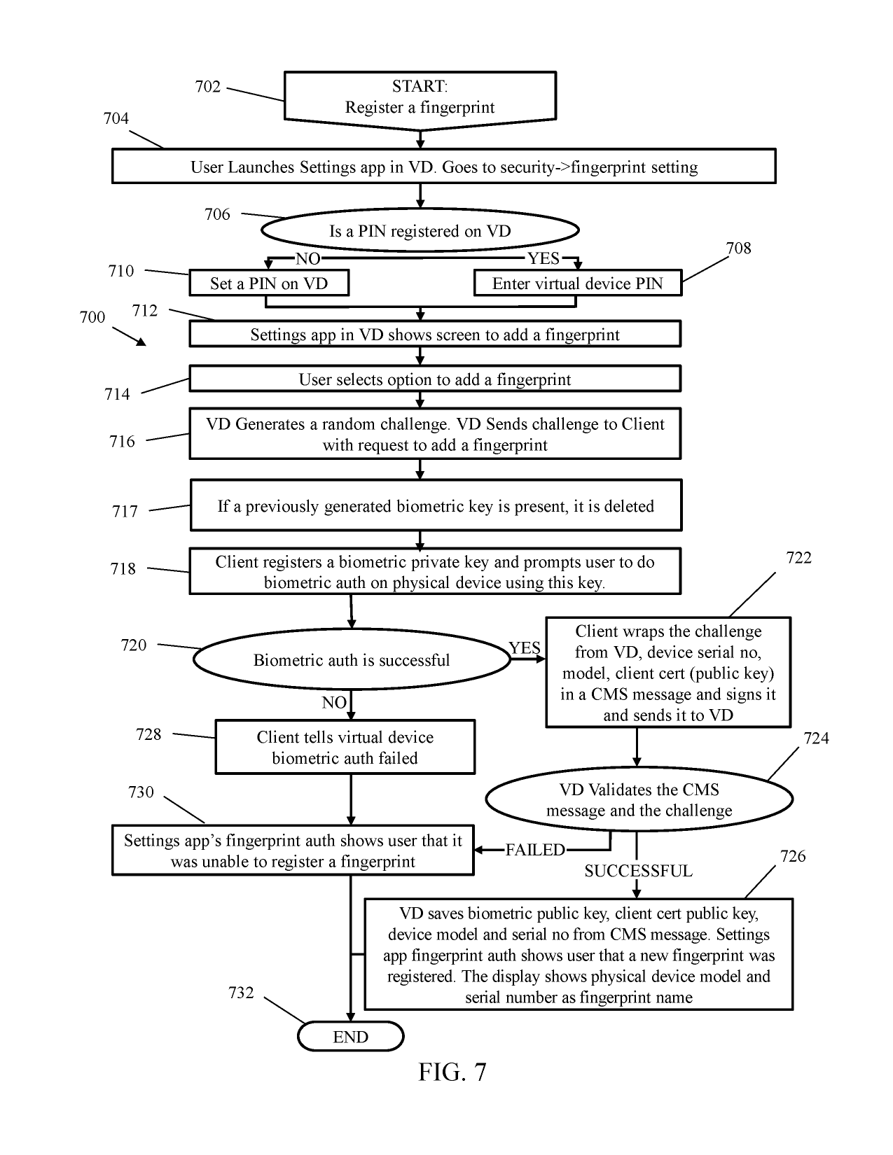

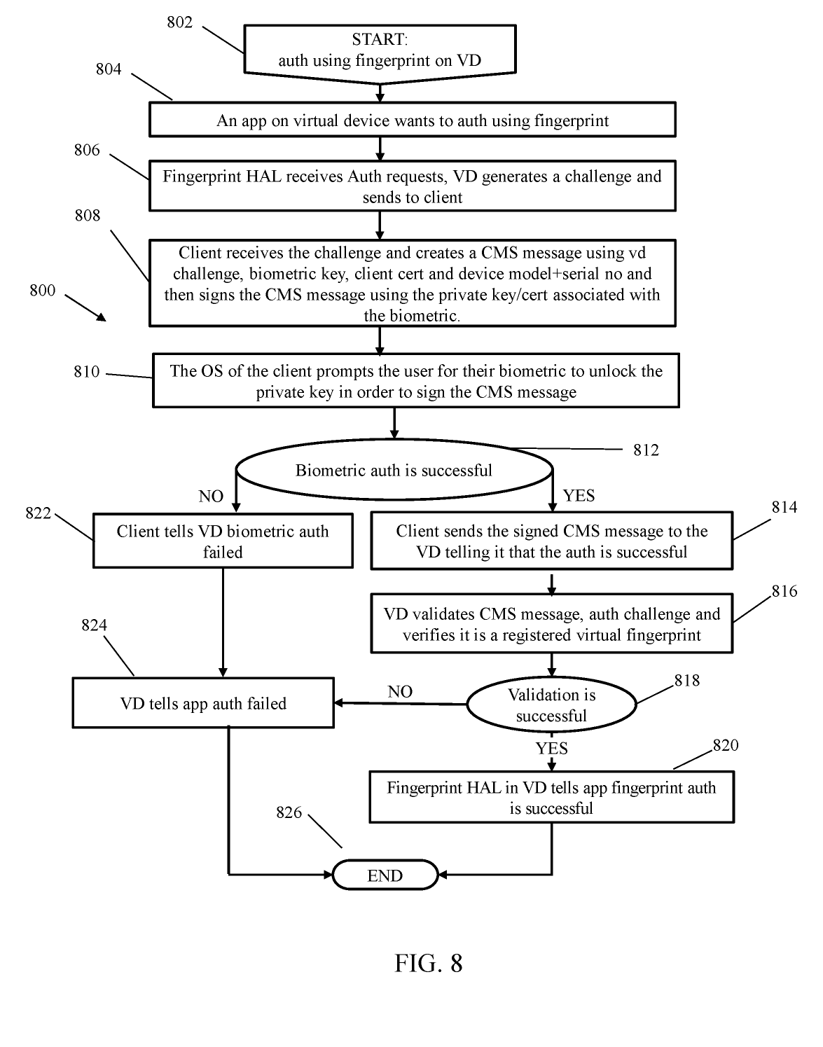

The primary operations to be performed by the module fingerprintHAL are register a fingerprint 700, FIG. 7, respond to authentication requests (pass/fail/error) 800, FIG. 8 remove a previously registered fingerprint (not shown), or list all registered fingerprints (not shown).

In an Android operating system there is no module or API that has the built-in capability of exporting the user's fingerprint. Instead, the fingerprint hardware captures the print, and all further communication occurs through the fingerprint HAL. In this regard, the HAL is configured to communicate with the fingerprint hardware and perform the desired processing operations.

In general, most mobile applications create a private/public keypair on the device with an authentication requirement that the biometric authentication must be used when using the private key for a cryptographic operation. This operation is usually an encrypt or sign operation of some data provided by a server after a “client” application on the device provides an initial authorization request.

In some instances, the client may perform a cryptographic operation (e.g., encryption or signing) request using the private key. While performing the cryptographic operation, the client may be prompted for their biometric by the underlying operation system’s biometric function, and upon successfully presenting the biometric, finishes the cryptographic operation. Once the cryptographic operation is complete, the result is sent to the server to prove use of the cryptographic key protected by the biometric.

According to certain embodiments, during registration, there may be a first registration step which is sued to establish the biometrical protected cryptographic key and share the public key with the server/service. This registration may require proof of ownership of the private key. Once the biometrical protected cryptographic key has been established, future biometric authentication challenges may use this pre-shared public key to validate that the user has performed a cryptographic operation using the private key that requires biometrics in order to use the key. In certain embodiments, the cryptographic operation may require the user to either sign or encrypt some type of challenge data or shared information that is not easily guessable.

In an Android environment, when registering a biometric key, an application can use the android API "setInvalidatedByBiometricEnrollment" which will invalidate keys when a new biometric is registered on the device. Thus, any previously registered biometrics are invalidated when for example, an unauthorized user determines how to add a biometric to a person’s mobile device.

If a user wants to add a new fingerprint, the Android OS will require a PIN/password/pattern to be created and will ensure authentication using a PIN/password/pattern before allowing the user to add a new fingerprint.

To allow virtual device applications to interact with the fingerprint hardware, a fingerprint HAL may be implemented which responds with a successful scan of fingerprint whenever a user wants to add a fingerprint or to authorize an action using fingerprint. The HAL does not have direct access to any hardware. It accesses the hardware via the client as a proxy. If a user wants to register a fingerprint, the HAL responds by sending a request to the client to register the fingerprint and return proof.

A workflow in accordance with an embodiment in which a message may be sent from a virtual device to the client apps to access the fingerprint scanner and to respond back to the virtual device with the result of the scan.

In general, the client module will first generate a biometric private/public key pair for an account configured on the client's physical device. The virtual device user will need to use the settings application on the virtual device and register a fingerprint for each account on their client side physical device in order for applications on the virtual device to be able to use fingerprint authentication. If two physical devices are to be associated with a single virtual device and a single account, they must each be registered separately. If the physical device supports facelD and not fingerprint, then the client can use facelD for authenticating the user but the virtual device will still use the fingerprint HAL and attempt to authorize the user as if a fingerprint sensor is present in the virtual device. That is, the intermediate layer responsible for confirming authentication performs relative to the virtual devices in a consistent manner, irrespective of the actual physical biometric identification process employed.

A workflow 700 for registering a fingerprint with a virtual device is illustrated as a flow chart in FIG. 7. A user of a virtual device who wants to allow applications on the virtual device to be able to use biometric authentication 702. The user will launch the settings application 704 on the virtual device, and attempt to register a fingerprint.

A check 706 may be made to determine whether a PIN is already registered on the virtual device. If yes, then a request 708 for the user to enter the PIN will be displayed at the client device, otherwise, an instruction 710 to set a PIN may be displayed. Next, the virtual device settings application will provide the option to add a fingerprint 712. The user selects 714 this option, and the fingerprint HAL in the virtual device will generate 716 a random string (i.e., a challenge) and send a biometric registration request to the client. When the client receives the biometric registration request, it will check if it has previously generated a biometric key for the client account used for the current session. If it finds one then it will delete it 717.

The client will then generate 718 a new biometric key on physical device and use it to authenticate the user using the physical device's biometric capabilities. Upon successful biometric authentication 720 (user can use a fingerprint if a sensor exists or use the faceID) client will create a CMS message with the challenge from the virtual device, device serial number and model, public key of the client cert use for the current session and sign the CMS message using the biometric. In this example, the biometric may be associated with a private key stored in the hardware of the physical device. As such, whenever a cryptographic operation is performed (e.g., a platform API to cryptographically sign (in Rivest-Shamir-Adleman (RSA), this is equivalent to an encrypt private key operation) the challenge text and place the resulting cryptographic signature into a CMS (e.g., PKCS#7) formatted message.

The challenge text may be sent by the server, and the challenge text may be 128 bytes of random data that the server generates, remembers, and sends to the client. Alternatively, the challenge text may be a server generated one-time password (OTP), or an auth token created by an authentication system.

The client will then generate 718 a new biometric key on physical device and use it to authenticate the user using the physical device's biometric capabilities. Upon successful biometric authentication 720 (user can use a fingerprint if a sensor exists or use the faceID) client will create a CMS message with the challenge from the virtual device, device serial number and model, public key of the client cert use for the current session and sign the CMS message using the biometric key it just generated 722. The virtual device receives the CMS message from the client, then validates 724 the CMS message and the challenge. If the validation is successful, then the fingerprint HAL will save 726 this information on persistent storage of the virtual device and use them later when apps want to authenticate using fingerprint. This will be referred to as a virtual fingerprint going forward. If the validation is unsuccessful, then the setting application informs the user that the registration attempt was unsuccessful 730.

According to certain embodiments, during validation, the server may have previously saved the public key during registration. As such, when the server issues a biometric challenge to a client, the server is expecting that the client proves its ownership of the biometric key by asking the client to sign the data. When the client returns the signed CMS message, the server may use the saved public key by performing a verify or decrypt operation of the signature of the data in the CMS message using the public key. If the server fails to decrypt or verify, then the client used an incorrect key and the authentication attempt is denied. In certain embodiments, the server may not have access to the biometric data – only the public key which is a representation of the biometric. Thus, by using the appropriate private key in a cryptographic operation, the client can trigger the biometric prompt, which results in signed/encrypted data.

If the biometric authentication 720 is unsuccessful, then the workflow proceeds to 728, where the client indicates to the virtual device that the authentication has failed, and the setting application informs the user that the registration attempt was unsuccessful 730. After either an unsuccessful attempt or a successful attempt leading to saving the information, the workflow ends 732.

A workflow 800 for authentication using the stored fingerprint information is shown in the flowchart of FIG. 8. From a starting point, 802, control passes to a third party app on the virtual device that has a need to authenticate 804 using biometric authentication. The fingerprint HAL in the virtual device OS will receive 806 the request to perform an authentication using the fingerprint HAL. In order for this to work, the fingerprint HAL should already have at least one virtual fingerprint registered using a method such as that shown in FIG. 7, otherwise applications on the virtual device will not get the option to authenticate using fingerprint.

When the fingerprint HAL receives the authentication request from a third party application on the virtual device, it will generate a random string (i.e., a challenge), and forward the challenge to the client. The client receives the challenge, and creates a CMS message using the virtual device challenge, biometric key, client certification, and the device model and identification numbers, and then signs the CMS message using the private key/certification associated with the biometric 808. The Client should then prompt the user on the physical device for a biometric challenge 810 (e.g., scan face ID or fingerprint) to unlock the private key in order to sign the CMS message. Upon a successful challenge 812, the client sends the CMS message to the virtual device to tell it that the authorization is successful 814. On an unsuccessful challenge, the client informs 822 the virtual device that the biometric authorization has failed, and then the virtual device informs 824 the application that the authorization has failed.

When the fingerprint HAL in the virtual device receives the result of the authentication operation, it will validate 816 the CMS message and the challenge and then verify that one of the virtual fingerprints previously registered (from 700 above) matches the public keys and device model and serial number of authentication CMS message. Next, if validation is successful 818, it informs the application that the fingerprint authorization is successful 820 or failed 824. It is possible that the client does a successful authentication, generates a valid CMS message but the virtual device rejects the request because it cannot find a previously registered virtual fingerprint (from 700 above). This can happen, for example, if a virtual device is re-provisioned. An appropriate message should be shown to the user telling him that he needs to register a fingerprint for the client he is using. The workflow then ends 826.

As will be appreciated, though the examples above relate primarily to fingerprint scans, other biometric identifiers may be used. For example, if a physical device uses face ID rather than fingerprint scanning, then the clients can use the physical device's APIs to access a faceID module, and to send results to the virtual device upon successful faceID authentication. The virtual device APIs can be hardware agnostic in that they only need to be informed on a successful authentication attempt, irrespective of what particular biometric authentication is employed. That is, iris scans, retinal scans, fingerprints, palm prints, face ID, or any other biometric check can be processed in the same manner. The APIs only need to receive an indicator that a biometric authentication check was successful. Clients on physical devices can use fingerprint scan, faceID, or any other biometric authentication system.

Furthermore, if the system encounters a physical device that lacks a biometric sensor, or in the case that an existing biometric sensor is not functioning properly, it can adapt to the situation. If, for example, a user used some other physical device previously which had biometric support and registered them with a particular virtual device, the virtual device OS will see that fingerprints are registered and it will present the option to use biometric authentication to third party applications. When these applications attempt to use biometric authentication, they will get an error and the user can then login using username/password for the third party application.

Though the particular embodiments are illustrated in a one-to-one manner, the skilled artisan understands that the concept may be expanded to more complex interactions. In particular, it may be common to have a single client having accounts allowing use of different virtual devices, or a single virtual device that is connected to several different client devices.

In the first case, each account on the client device will need a registration with each of the virtual devices. This means that in each account on the clients connected with a different virtual devices, there is a unique keypair created in the client that requires biometric authorization. Each virtual device will have a different public key registered with that client. Thus, the virtual device will see one "fingerprint" registered but the client may have multiple, one for each virtual device it can connect to.

In the second case, a user may have both a phone and a tablet that each connect to the same virtual device. Each client will need to register their keypair representing a fingerprint on their device with the virtual device. Thus, the virtual device will have multiple "fingerprints" registered, one for each device that connects to them.

In these more complex arrangements, the processes for registering and authenticating may all be the same as described with reference to FIGS. 7 and 8, with a minor difference that there are multiple registrations either on the client (multiple virtual device accounts associated with the same client) or the virtual device (multiple client devices registered with the same virtual device).

According to certain embodiments, a biometric credential may be established on a mobile device for an application and account. The mobile device may be equipped with biometric sensors and cryptography access through biometrics. In this procedure, a client application may be instructed by an authentication server to establish a biometric protected cryptographic keypair in device hardware. The client may prove ownership/access to the keypair through a cryptographic signing process of a server provided challenge string consisting of a one-time use, random string of characters. The client may respond with a cryptographic message syntax (CMS) containing the challenge string and signature, along with the public key of the cryptographic keypair. The server may then validate the challenge string and its signature using the public key provided by the client. Upon a successful validation, the server may return an authentication token that contains information about the user, their virtual device, and includes a bundle of “biometric information” including a hashed value of the public key that was used to establish a successful biometric challenge. The resulting authentication token may be signed by a trusted credential to prove the creator of the authentication token.

After successful validation, connection by the client to the virtual device associated with the account/authentication token may be established, and a biometric may be required to connect to the virtual device. If the authentication token contains biometric authentication information, it may create a CMS message that contains the hash value of the authentication token using the same biometric keypair used to obtain the authentication token. The client may send the original authentication token (with biometric information) and the biometric signed CMS message containing the hash of the authentication token to the virtual device. The virtual device may retrieve the authentication token and validate its contents. If the virtual device determines that there is a biometric bundle inside the validated authentication token, the virtual device may search for the biometric CMS message that was also sent. If the CMS message is missing, the virtual device will reject the connection. Otherwise, the virtual device may verify the biometric CMS message and validate that it matches the biometric data in the authentication token (same validated public key used by both CMS messages). If the CMS message does not verify or did not use the same keypair for signing, the connection is rejected.

In certain embodiments, after the user enables biometric access in the virtual device, any application can use the biometric authentication features used to protect access to cryptographic keys in virtual devices. This permits applications that require biometric protection of cryptographic keys used by many authenticator applications, web applications and services that use passkeys and/or cryptographic keys that are protected by biometrics. In some embodiments, the virtual device may provide a keystore that is protected by hardware security modules (HSMs). Keys in this keystore may include authentication that requires a PIN/password and/or a biometric. The authentication requirements may be specified when the key is created in the keystore of the virtual device.

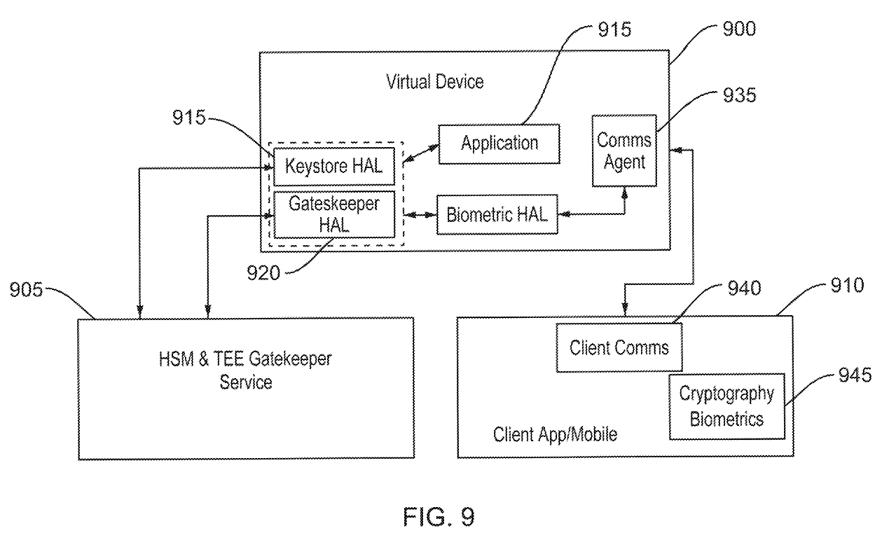

FIG. 9 illustrates an example procedure for an application 925 to create a key, according to certain embodiments. For example, FIG. 9 illustrates interactions between a virtual device 900, HSM and trusted execution environment (TEE) As illustrated in FIG. 9, an application 925 may create a keypair with attributes that require biometric authentication in the keystore. The attributes may include, but not limited to, for example, an attribute to instruct the keystore to invalidate the key if a new biometric is registered. The attributes may also include setting an amount of time in which authentication is valid. The attributes may further include enabling authentication while the device is on body (e.g., requires an on body sensor). The attributes may also include setting the biometric authentication to perform on each use of the key, or if it will be automatically granted within a specified time period(e.g., no more often than 1 minute). In other example embodiments, the attributes may include an attribute that specifies that one must use biometric or if you can allow a PIN instead. The keystore HAL 915 may construct a request to create the keypair with the biometric authorization attributes and send them to the HSM and TEE gatekeeper service 905. As illustrated in FIG. 9, the HSM and TEE gatekeeper may be located in separate servers. In some embodiments, if the HSM and TEE were in FIG. 3, the HEE and TEE may represent additional services overlaid by/behind the notification and other services 357. Alternatively, in FIG. 4, the HSM and TEE may represent another service such as, for example, 451, 453, 455, and 457. Additionally, in some embodiments, FIG. 6 may include HAL components for the HSM and gatekeeper services in 630 of FIG. 6. With the received keypair and biometric authorization attributes, the HSM and TEE gatekeeper 905 may generate the key protected by a hardware security module with specific authorization attributes that require biometric authentication, bind the attributes to the keypair, and return the resulting keyblob to the keystore of the virtual device 900. According to certain embodiments, the keyblob may represent a private/secret key in the Android keystore. In particular, a blob may represent the actual private key, a handle/pointer to a key stored/managed elsewhere, or encrypted and protected key material. In the case of an HSM, the keyblob may be encrypted by hardware keys that only the HSM can see/use. In other embodiments, there may be special key characteristics or tags such as how the key can be used, whether it requires authentication, if it expires, etc. These values may be enforced by Android (e.g., software) or by the HSM (e.g., hardware). The keystore HAL 915 may persist (e.g., permanently store) the protected key in the application’s keystore 915 and returns a representation of the key to the application 925. At a point in time in the future, the application 925 may attempt to use the keypair to sign or encrypt data (e.g., an authentication challenge or some other function which results in a call to the keystore HA).

According to certain embodiments, the keystore may send the signed/encrypted request with the keyblob to the HSM service 905, and the HSM service (905) may determine that the key requires special authentication and returns a “needs authentication” response back to the keystore. The keystore may receive the authentication needed response and may call the gatekeeper HAL 920 to obtain an internal authentication token for the keyblob. The gatekeeper HAL 920 may notice that the authentication required is biometric, and transmits a message to the biometric HAL 930 of the virtual device 900 to validate the user’s biometric. In response to the received message, the biometric HAL 930 creates a one-time random challenge string and transmits the one-time random challenge string along with the biometric information from the authentication token back to the client 910 via the comms agent 935.

In certain embodiments, the client 910 may receive the challenge and create a CMS message and prompt the user to verify their biometric by signing CMS message data. Once the biometric process is complete on the client 910, the signed CMS may be returned to the biometric HAL 930. The biometric HAL 930 may verify the CMS message and return the results to the gatekeeper HAL 920. The gatekeeper HAL 920 may prepare the results and transmit the request to the gatekeeper service 905 to obtain the keystore authentication token. The gatekeeper service 905 may verify the results from the gatekeeper HAL 920 and return the gatekeeper authentication token to the gatekeeper service 905.

According to certain embodiments, the keystore HAL 915 receives the gatekeeper authentication token and resubmits the sign/encryption request with the keyblob to the HSM and TEE gatekeeper service 905. The HSM and TEE gatekeeper service 905 validates the gatekeeper produced authentication token, unwraps the keyblob, and signs/encrypts the data. Once signed/encrypted, the HSM and TEE gatekeeper service 905 returns the data (e.g., the signed/encrypted data) to the keystore HAL 915. Once the signed/encrypted data is received, the keystore HAL 915 returns the signed/encrypted data to the application 925.

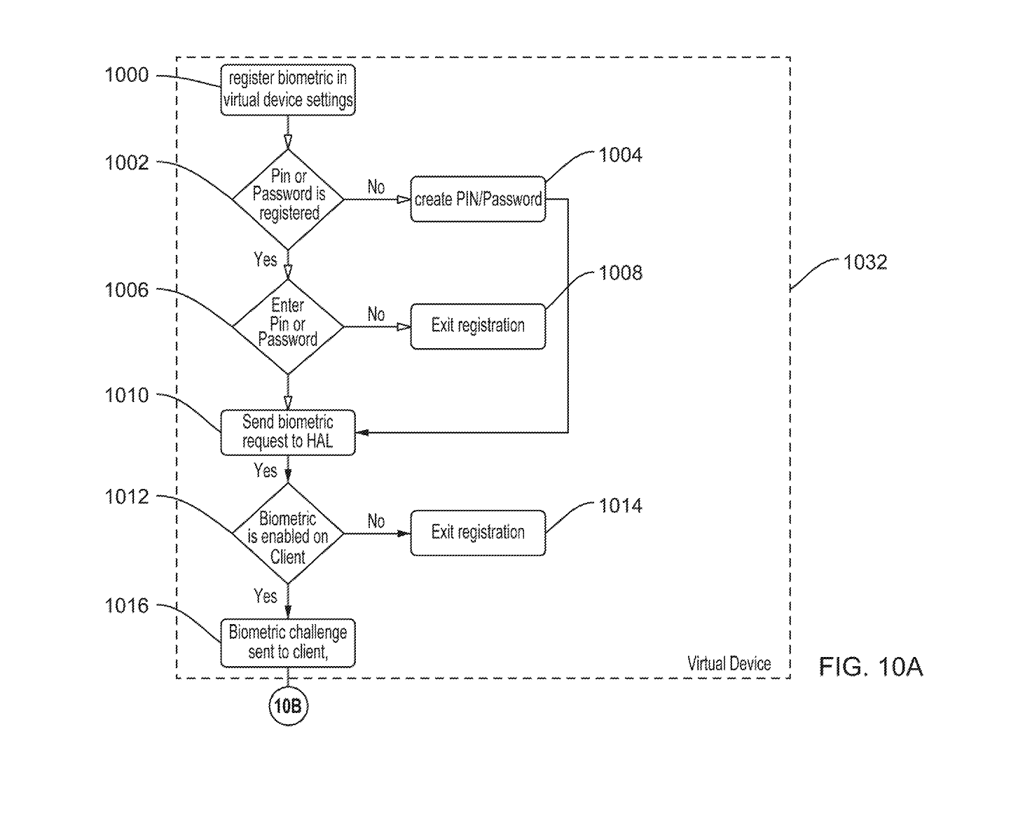

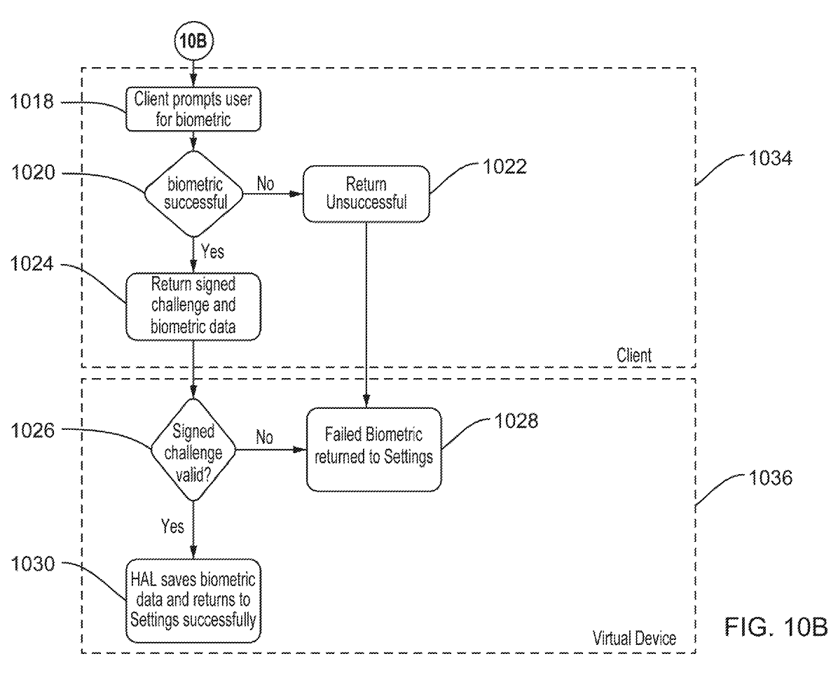

FIGS. 10A-10C illustrate an example flow diagram of biometric authentication for a lock screen in a virtual device, according to certain embodiments. According to certain embodiments, the virtual device 1032 may be configured to require a PIN or a biometric after various events such as, for example, being powered on, waking up from being asleep or disconnected, or after some amount of time configured by administrators. When the screen of a device such as, for example, a client or mobile device 1034, is locked, a PIN/biometric screen is presented and the user of the device 1034 may enter their PIN or use their biometric to open the virtual device 1032.

To use biometrics, the user may register 1000 their biometric with the virtual device 1032 using its settings application. For example, before the user can register their biometric, they may setup a PIN or password 1002 using the settings application. If the PIN or password has not yet been setup, the user may create a PIN or password 1004. Once the PIN/password has been created, the user may enter the PIN or password 1006 to access the virtual device 1032. However, if no PIN/password is entered, the user exists registration 1008. The settings application may offer to register the biometric with the virtual device 1032. The virtual device 1032 may then send 1010 a biometric request to the HAL, and inspect the original authentication token used to connect to the virtual device 1032 for biometric information 1012, and send 1016 the biometric information with the biometric challenge to the client. If there was no biometric information 1014 in the authentication token used to connect and the client 1034 has not setup biometrics, the virtual device 1032 cannot request biometrics from the client . If there are biometrics 1018, 1020 in the authentication token used to connect to the virtual device 1032, the virtual device 1032 sends the client a biometric challenge 1024 containing a one-time use random string. If there are no biometrics, an unsuccessful return response is received 1022 at the client 1034. When the client receives the challenge, the signed challenge is valid 1026, HAL saves biometric data and returns to settings successfully 1030. Additionally, when the client 1034 receives the challenge, the client 1128 may create a CMS message containing the challenge, sign in 130 using the biometric protected keypair, and return the results to the virtual device. If the signed challenge is not verified 1028, the virtual device 1032 may prompt the user for a PIN or password to unlock the screen.

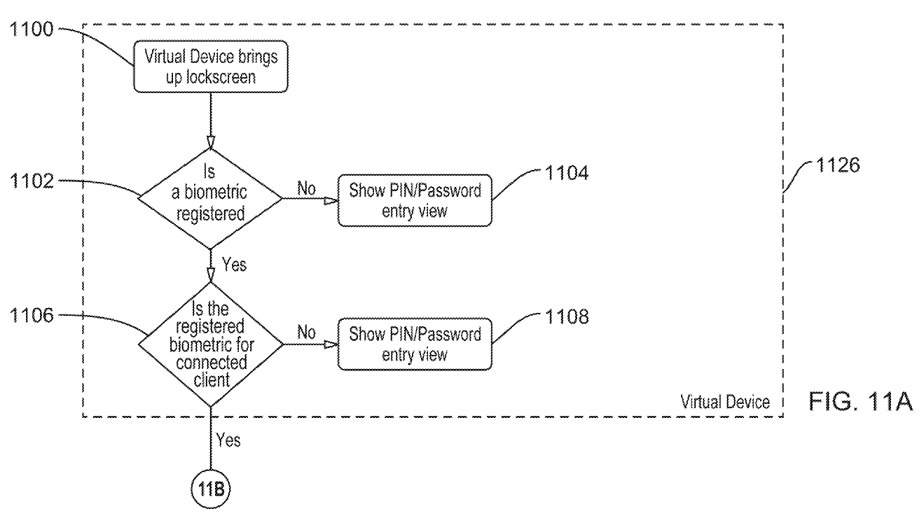

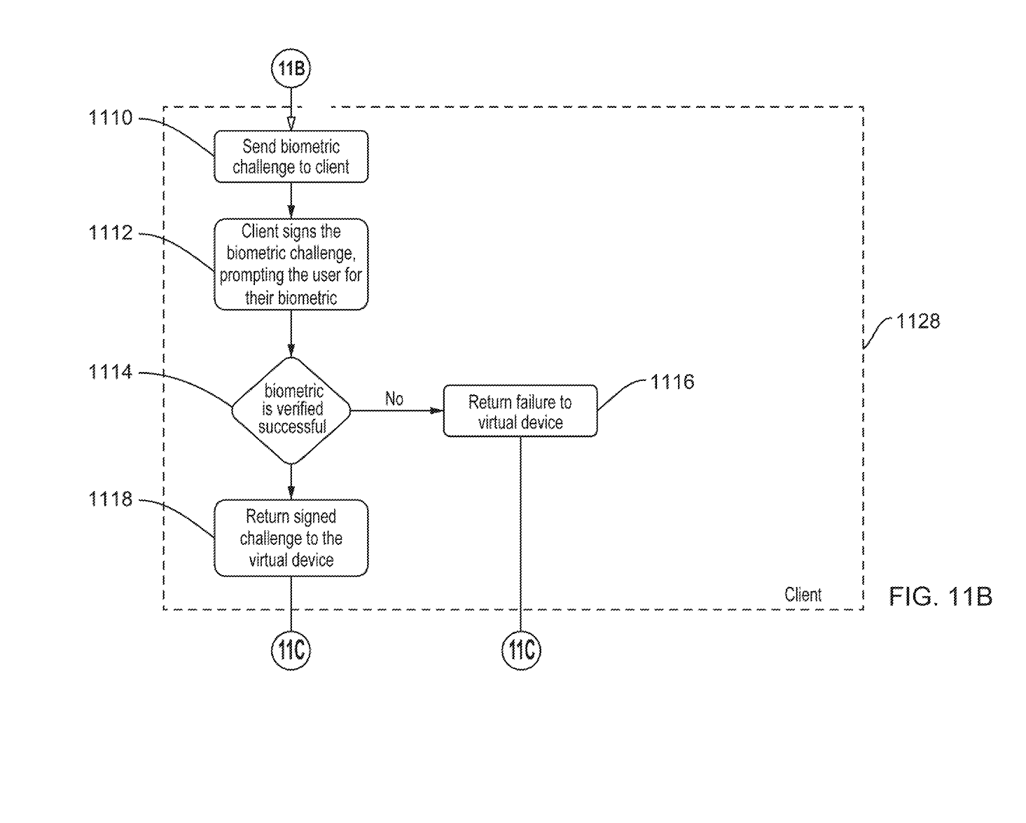

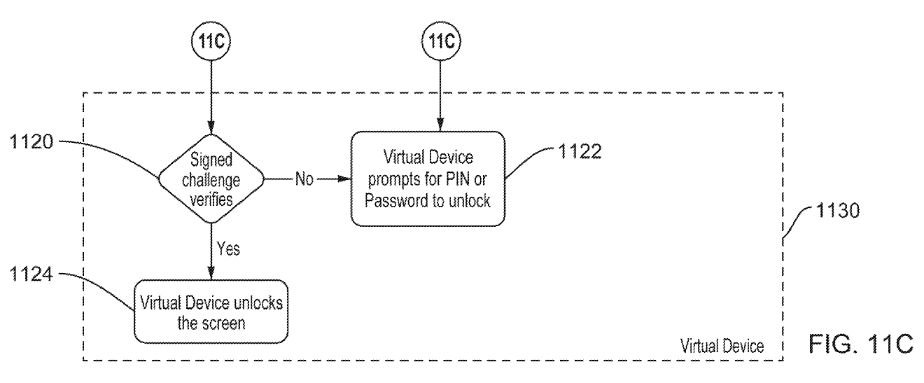

FIGS. 11A-11C illustrate an example flow diagram of biometric authenticated cryptography in a virtual device, according to certain embodiments. As illustrated in FIG. 11, a user may be authenticated to use a virtual device 1126. At 1100, the virtual device 1126 brings up a lock screen. At 1102, the virtual device 1126 determines whether a biometric of the user is registered. If no, at 1104, the user is prompted to enter a PIN/password. If the virtual device 1126 determines that a biometric is registered, at 1106, the virtual device 1126 further determines whether the registered biometric is for a connected client 1128. If no, at 1108, the user is prompted to enter a PIN/password. If yes, at 1110, the virtual device 1126 sends a biometric challenge to the client 1128. At 1112, the client signs the biometric challenge, prompting the user for their biometric information. At 1114, the client 1128 determines whether the biometric is successfully verified. If no, at 1116, the client 1128 returns a failure message to the virtual device 1126. If yes, at 1118, the client 1128 returns the signed challenge to the virtual device 1126.

At 1120, the virtual device 1126 determines whether the signed challenge is verified. If no, at 1122, the virtual device 1126 prompts the user for a PIN or password to unlock the virtual device 1126 screen. If yes, at 1124, the virtual device 1126 unlocks the screen.

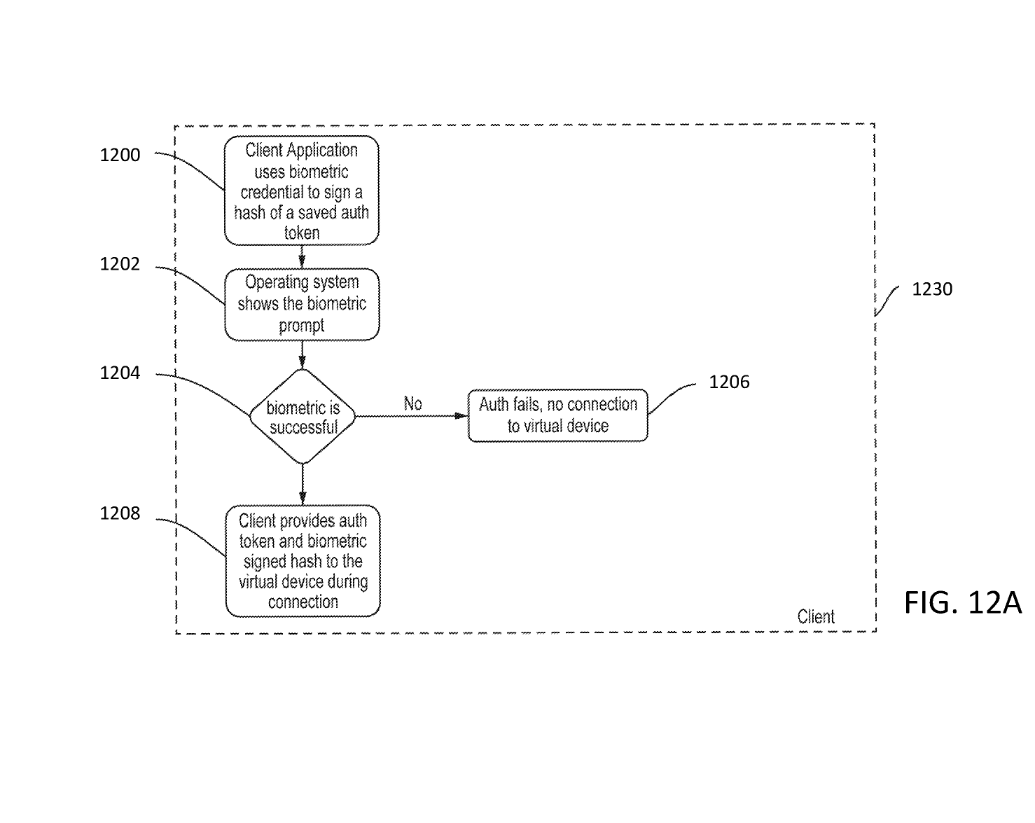

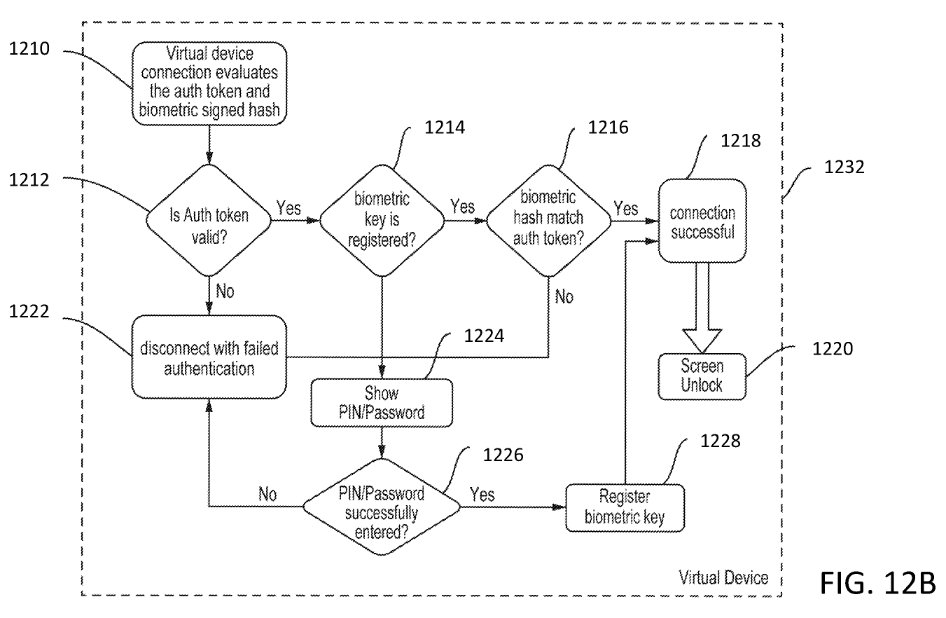

FIGS. 12A-12B illustrate an example flow diagram biometric authentication for a lock screen in a virtual device, according to an embodiment. At 1200, the client application of the client 1230 uses biometric credentials of the user to sign a hash of a saved authentication token. At 1202, the operating system of the client 1230 shows the biometric prompt. At 1204, the client 1230 determines whether the biometric is successful. If no, at 1206, the client 1230 determines that the authentication has failed, and does not establish a connection to the virtual device 1232. If yes, at 1208, the client 1230 provides the authentication token and biometric signed hash to the virtual device 1332 during connection with the virtual device 1232.

At 1210, the virtual device 1232 receives the authentication token and biometric signed hash from the client 1230, and evaluates the authentication token and biometric signed hash. During the evaluation, the virtual device 1232 determines, at 1212, whether the authentication token is valid. If yes, at 1214, the virtual device determines whether the biometric key is registered. If the biometric key is registered, at 1216, the virtual device 1232 determines whether the biometric hash matches the authentication token. If yes, at 1218, the virtual device 1232 determines that the connection with the client 1230 is successful. At 1220, the virtual device unlocks the screen after determining that the connection with the client 1230 is successful. .

At 1222, if the authentication token is not valid, the virtual device 1232 disconnects with the client 1230, and the authentication is deemed as failed. At 1224, if the biometric key is not registered, the user is prompted to provide a PIN/password. At 1226, the virtual device 1232 determines whether the PIN/password was successfully entered. If no, at 1222, the virtual device 1232 disconnects with the client 1230 with a failed authentication. If the PIN/password was successfully entered, at 1228, the virtual device 1232 registered the biometric key, and establishes a successful connection 1318 with the client 1230. Further, if at 1216, the virtual device 1232 determines that the biometric hash does not match the authentication token, the a authentication is deemed as failed, and the virtual device disconnects 1222 from the client 1230.

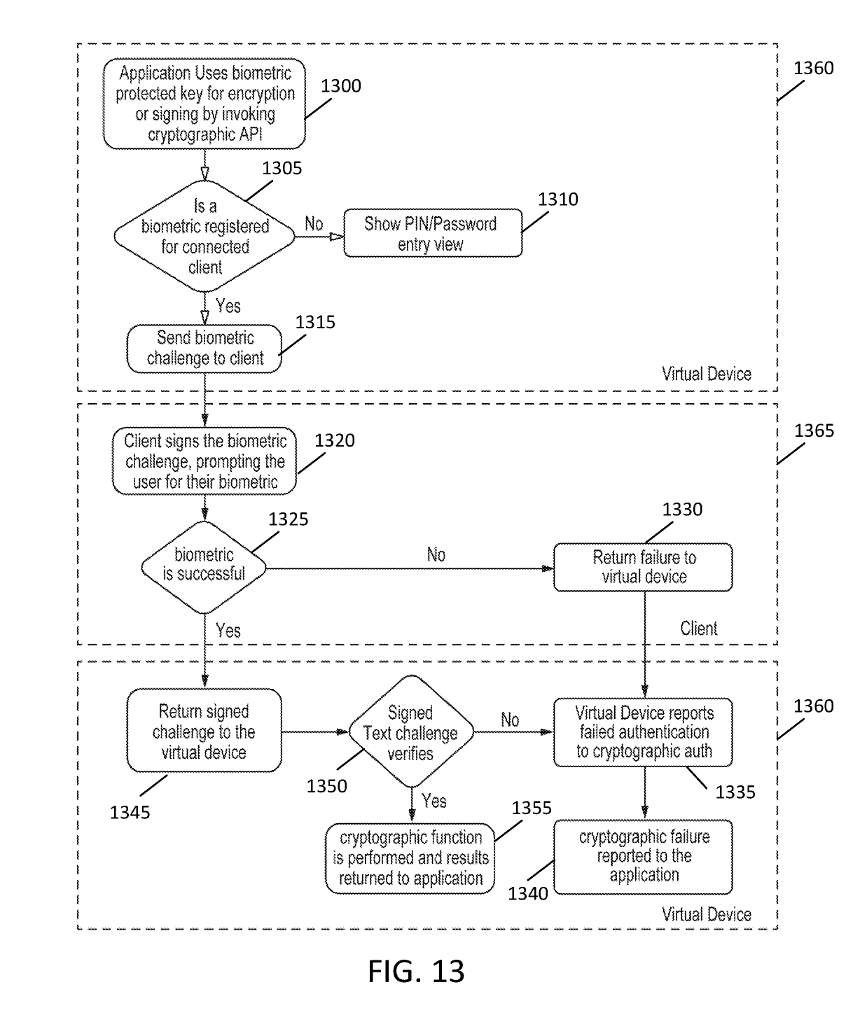

FIG. 13 illustrates an example flow diagram of biometric authenticate cryptography in a virtual device according to one embodiment. At 1300, the application at the user device 1360 uses a biometric protected key for encryption or signing by invoking a cryptographic API. At 1305, the virtual device 1360 determines whether there is a biometric registered for the connected client. If no, at 1310, a PIN/password is shown at the entry view of the application. If yes, at 1315, the virtual device 1360 sends a biometric challenge to the client.

At 1320, the client 1365 signs the biometric challenge, which prompts the user for their biometric. At 1325, the client 1365 determines whether the biometric is successful. If no, at 1330, the client device 1365 returns a failure indication to the virtual device. If yes, at 1345, the client 1365 returns the signed challenge to the virtual device 1360. At 1350, the virtual device 1360 determines whether the signed text challenge is verified. If no, at 1335, the virtual device 1360 reports the failed authentication to cryptographic auth. At 1340, the virtual device 1360 reports the cryptographic failure to the application. If on the other hand, the signed text challenge is verified, at 1355, the virtual device 1360 performs the cryptographic function, and the virtual device 1360 returns the results of the cryptographic function to the application. In certain example embodiments, when the virtual device 1360 performs the cryptographic operation, the operation may be performed by the HSM at the direction/control of the virtual device 1360.

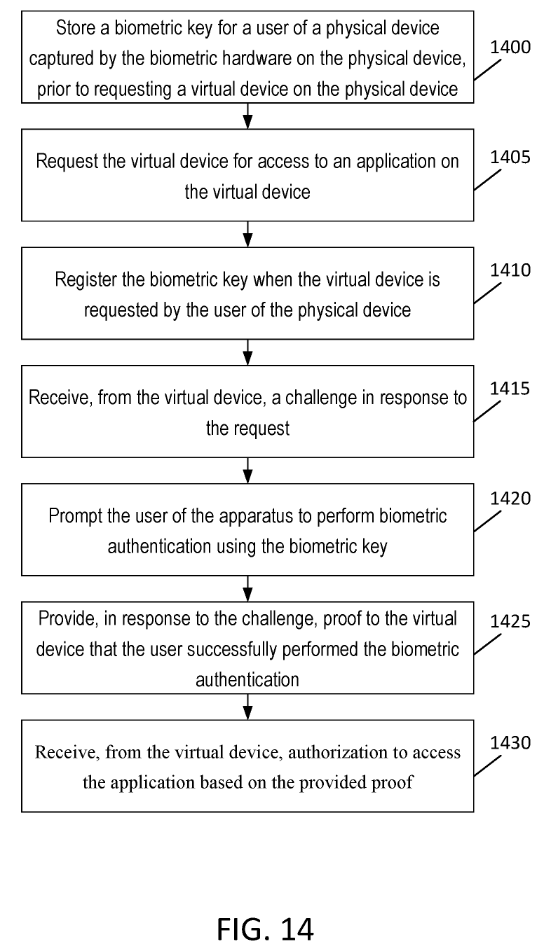

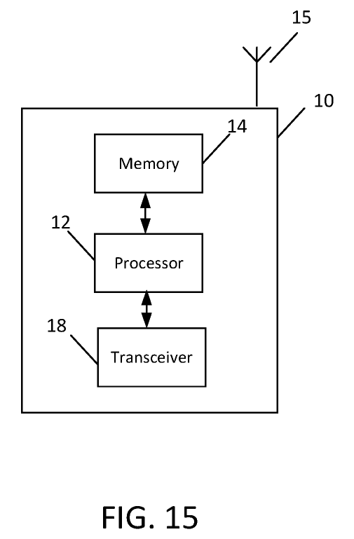

FIG. 14 illustrates an example flow diagram of a method, according to an embodiment. In an example embodiment, the method of FIG. 14 may be performed by a computer or mobile device similar to apparatus 10 illustrated in FIG. 15.

As illustrated in FIG. 14, the method may include, at 1400, storing a biometric key for a user of a physical device captured by the biometric hardware on the physical device, prior to requesting a virtual device on the physical device. The method may also include, at 1405, requesting the virtual device for access to an application on the virtual device. The method may further include, at 1410, registering the biometric key when the virtual device is requested by the user of the physical device. In addition, the method may include, at 1415, receiving, from the virtual device, a challenge in response to the request. Further, the method may include, at 1420, prompting the user of the physical device to perform biometric authentication using the biometric key. The method may also include, at 1425, providing, in response to the challenge, proof to the virtual device that the user successfully performed the biometric authentication. The method may further include, at 1430, receiving, from the virtual device, authorization to access the application based on the provided proof.

According to certain embodiments, the method may also include generating, in response to the challenge, a cryptographic message syntax message comprising the challenge. According to some example embodiments, the method may also include signing the cryptographic message syntax message using the biometric key. According to other example embodiments, the method may include transmitting the signed cryptographic message syntax message to the virtual device.

In certain embodiments, the cryptographic message syntax message may include at least one of challenge information, client certification public key information, device identifying information correspond to the physical device, or a public key corresponding to an item of biometric identification. In some example embodiments, the method may further include opening a lock screen of the virtual device. In other example embodiments, the biometric key may be used to open the lock screen of the virtual device, and wherein the challenge comprises a one-time use random string. In some example embodiments, the biometric key may be applicable to the application. In other example embodiments, the method may also include receiving, from the application during a cryptographic operation, a request for biometrics.

FIG. 15 illustrates an apparatus 10, according to an embodiment. In certain example embodiments, apparatus 10 may be an element in a communications network, computer network, or associated with such a network. For example, apparatus 10 may be a computer or mobile device.

In some example embodiments, apparatus 10 may include one or more processors 12, one or more computer-readable storage medium 14 (for example, memory, storage, or the like), one or more radio access components (for example, a modem, a transceiver, or the like), and/or a user interface. It should be noted that one of ordinary skill in the art would understand that apparatus 10 may include components or features not shown in FIG. 15.

As illustrated in the example of FIG. 15, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, DSPs, field-programmable gate arrays (FPGAs), application-specific integrated circuits (ASICs), and processors based on a multi-core processor architecture, as examples. While a single processor 12 is shown in FIG. 15, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-14.

Apparatus 10 may further include or be coupled to a memory 14 (internal or external), which may be respectively coupled to processor 12 for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-14.

In some example embodiments, apparatus 10 may also include or be coupled to one or more antennas 15 for receiving a signal and for transmitting signals from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna 15 and demodulate information received via the antenna 15 for further processing by other elements of apparatus 10. In other embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain embodiments, apparatus 10 may optionally be configured to communicate with other similar apparatuses (in any combination) via a wireless or wired communication links.

According to certain example embodiments, processor 12 and memory 14 may be included in or may form a part of processing circuitry or control circuitry. In addition, in some example embodiments, transceiver 18 may be included in or may form a part of transceiving circuitry.

In other example embodiments, apparatus 10 may be controlled by memory 14 and processor 12 to store a biometric key for a user of the apparatus captured by the biometric hardware on the apparatus, prior to requesting a virtual device on the apparatus. Apparatus 10 may also request the virtual device for access to an application on the virtual device. Apparatus 10 may further be controlled by memory 14 and processor 12 to register the biometric key when the virtual device is requested by the user of the apparatus. Apparatus 10 may also be controlled by memory 14 and processor 12 to receive, from the virtual device, a challenge in response to the request. In addition, apparatus 10 may be controlled by memory 14 and processor 12 to prompt the user of the apparatus to perform biometric authentication using the biometric key. Apparatus 10 may further be controlled by memory 14 and processor 12 to provide, in response to the challenge, proof to the virtual device that the user successfully performed the biometric authentication. Further, apparatus 10 may be controlled by memory 14 and processor 12 to receive, from the virtual device, authorization to access the application based on the provided proof.

In some example embodiments, an apparatus (e.g., apparatus 10) may include means for performing a method, a process, or any of the variants discussed herein. Examples of the means may include one or more processors, memory, controllers, transmitters, receivers, and/or computer program code for causing the performance of the operations.

Other example embodiments may be directed to an apparatus that includes means for performing any of the methods described herein including, for example, means for storing a biometric key for a user of the apparatus captured by the biometric hardware on the apparatus, prior to requesting a virtual device on the apparatus. The apparatus may also include means for requesting the biometric key when the virtual device is requested by the user of the apparatus. The apparatus may further include means for receiving, from the virtual device, a challenge in response to the request. Further, the apparatus may include means for prompting the user of the apparatus to perform biometric authentication using the biometric key. In addition, the apparatus may include means for providing, in response to the challenge, proof to the virtual device that the user successfully performed the biometric authentication. The apparatus may also include means for receiving, from the virtual device, authorization to access the application based on the provided proof.

Certain example embodiments described herein provide several technical improvements, enhancements, and/or advantages. For instance, in some example embodiments, it may be possible to enable applications running in a particular management domain for a particular user be accessible through a corresponding VC client application running on a mobile device. In other embodiments, it may be possible to enable various primary features including, for example biometrics to open a lock screen of the virtual device instead of requiring PIN or password, enable biometrics to open a lock screen of the virtual device instead of requiring a PIN or password. Other example embodiments may enable any android application, whether it be an authenticator, a banking or healthcare application that requires proof of identity using biometrics. With certain embodiments, android applications that use biometrics can run unmodified in virtual devices. Alternatively, the applications may be customized to use alternatives to biometrics or create their own biometric authentication functions.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to "one embodiment", "an embodiment", or "a specific embodiment" or similar terminology means that a particular feature, structure, or characteristic described in connection with the embodiment is included in at least one embodiment and may not necessarily be present in all embodiments. Thus, respective appearances of the phrases "in one embodiment", "in an embodiment", or "in a specific embodiment" or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit ("CPU"), at least one read-only memory ("ROM"), at least one random access memory ("RAM”), at least one hard drive ("HD"), and one or more input/output ("I/O") device(s). The I/O devices can include a keyboard, monitor, printer, electronic pointing device (for example, mouse, trackball, stylus, touch pad, etc.), or the like. In embodiments of the invention, the computer has access to at least one database over the network.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term "computer readable medium" is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A "computer-readable medium" may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A "processor" includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in "real-time," "offline," in a "batch mode," etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

As used herein, the terms "comprises," "comprising," "includes," "including," "has," "having," or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term "or" as used herein is generally intended to mean "and/or" unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by "a" or "an" (and "the" when antecedent basis is "a" or "an") includes both singular and plural of such term, unless clearly indicated within the claim otherwise (i.e., that the reference "a" or "an" clearly indicates only the singular or only the plural). Also, as used in the description herein and throughout the claims that follow, the meaning of "in" includes "in" and "on" unless the context clearly dictates otherwise. The scope of the present disclosure should be determined by the following claims and their legal equivalents.

We claim:

1. An apparatus, comprising:
at least one processor; and
at least one memory including computer program code which, when executed by the at least one processor, cause the apparatus to at least:
store a biometric key for a user of the apparatus captured by a biometric hardware on the apparatus, prior to requesting a virtual device on the apparatus;
request the virtual device for access to an application on the virtual device;
register the biometric key when the virtual device is requested by the user of the apparatus;
receive, from the virtual device, a challenge in response to the request;
prompt the user of the apparatus to perform biometric authentication using the biometric key;
provide, in response to the challenge, proof to the virtual device that the user successfully performed the biometric authentication; and
receive, from the virtual device, authorization to access the application based on the provided proof.

2. The apparatus according to claim 1, wherein the computer program code, when executed by the at least one processor, further causes the apparatus to at least:
generate, in response to the challenge, a cryptographic message syntax message comprising the challenge;
sign the cryptographic message syntax message using the biometric key; and
transmit the signed cryptographic message syntax message to the virtual device.

3. The apparatus according to claim 2, wherein the cryptographic message syntax message comprises at least one of the following:
challenge information,
client certification public key information,
device identifying information correspond to the apparatus, or
a public key corresponding to an item of biometric identification.

4. The apparatus according to claim 3, wherein the computer program code, when executed by the at least one processor, further causes the apparatus to at least, with the item of biometric identification:
open a lock screen of the virtual device.

5. The apparatus according to claim 4, wherein when the biometric key is used to open the lock screen of the virtual device, and wherein the challenge comprises a one-time use random string.

6. The apparatus according to claim 4, wherein the biometric key is applicable to the application.

7. The apparatus, according to claim 1, wherein the computer program code, when executed by the at least one processor, further causes the apparatus to at least:
receive, from the application during a cryptographic operation, a request for biometrics.

8. A method, comprising:
storing a biometric key for a user of a physical device captured by a biometric hardware on the physical device, prior to requesting a virtual device on the physical device;
requesting the virtual device for access to an application on the virtual device;
registering the biometric key when the virtual device is requested by the user of the physical device;
receiving, from the virtual device, a challenge in response to the request;
prompting the user of the physical device to perform biometric authentication using the biometric key;
providing, in response to the challenge, proof to the virtual device that the user successfully performed the biometric authentication; and
receiving, from the virtual device, authorization to access the application based on the provided proof.

9. The method according to claim 8, further comprising:
generating, in response to the challenge, a cryptographic message syntax message comprising the challenge;
signing the cryptographic message syntax message using the biometric key; and
transmitting the signed cryptographic message syntax message to the virtual device.

10. The method according to claim 9, wherein the cryptographic message syntax message comprises at least one of the following:
challenge information,
client certification public key information,
device identifying information correspond to the physical device, or
a public key corresponding to an item of biometric identification.

11. The method according to claim 10, further comprising, with the item of biometric identification:
opening a lock screen of the virtual device.

12. The method according to claim 11, wherein when the biometric key is used to open the lock screen of the virtual device, and wherein the challenge comprises a one-time use random string.

13. The method according to claim 10, wherein the biometric key is applicable to the application.

14. The method according to claim 10, further comprising:
receiving, from the application during a cryptographic operation, a request for biometrics.

15. A non-transitory computer readable medium encoded with instructions that, when executed in hardware, perform a process, the process comprising:
storing a biometric key for a user of a physical device captured by a biometric hardware on the physical device, prior to requesting a virtual device on the physical device;
requesting the virtual device for access to an application on the virtual device;
registering the biometric key when the virtual device is requested by the user of the physical device;
receiving, from the virtual device, a challenge in response to the request;
prompting the user of the physical device to perform biometric authentication using the biometric key;
providing, in response to the challenge, proof to the virtual device that the user successfully performed the biometric authentication; and
receiving, from the virtual device, authorization to access the application based on the provided proof.

16. The non-transitory computer readable medium according to claim 15, wherein the instructions, when executed in hardware, performs the process, the process further comprising:
generating, in response to the challenge, a cryptographic message syntax message comprising the challenge;
signing the cryptographic message syntax message using the biometric key; and
transmitting the signed cryptographic message syntax message to the virtual device.

17. The non-transitory computer readable medium according to claim 16, wherein the cryptographic message syntax message comprises at least one of the following:
challenge information,
client certification public key information,
device identifying information correspond to the physical device, or
a public key corresponding to an item of biometric identification.

18. The non-transitory computer readable medium according to claim 15, wherein the instructions, when executed in hardware, performs the process, the process further comprising, with the item of biometric identification:
opening a lock screen of the virtual device.

19. The non-transitory computer readable medium according to claim 18, wherein when the biometric key is used to open the lock screen of the virtual device, and wherein the challenge comprises a one-time use random string.

20. The non-transitory computer readable medium according to claim 16, wherein the biometric key is applicable to the application.

21. The non-transitory computer readable medium according to claim 15, wherein the instructions, when executed in hardware, performs the process, the process further comprising:
receiving, from the application during a cryptographic operation, a request for biometrics.
